(19) United States
(12) Patent Application Publication
(10) Pub. No.: US 2024/0242456 A1
(43) Pub. Date: Jul. 18, 2024

(54) MANIPULATION METHOD AND APPARATUS FOR VIRTUAL SPACE, ELECTRONIC DEVICE, AND STORAGE MEDIUM

(71) Applicant: Beijing Zitiao Network Technology Co., Ltd., Haidian District (CN)

(72) Inventors: Siyuan Wu, Beijing (CN); Wenkai Zhan, Beijing (CN); Panliang Wu, Beijing (CN); Cong Gong, Beijing (CN); Zhou Wang, Beijing (CN)

(21) Appl. No.: 18/415,405

(22) Filed: Jan. 17, 2024

(30) Foreign Application Priority Data
Jan. 17, 2023 (CN) 202310076564.2
Dec. 27, 2023 (CN) 202311828445.4

(51) Int. Cl. G06T 19/20; G06T 7/70

(52) U.S. Cl. CPC G06T 19/20; G06T 7/70; G06T 2219/2004; G06T 2219/2016

(57) ABSTRACT

A manipulation method and an apparatus for a virtual space, an electronic device, and a storage medium. The manipulation method including: determining a virtual character corresponding to a target terminal device in the virtual space from at least one first virtual image; and in response to a control operation on a target item in the at least one second object in the virtual space, acquiring state update information of the target item based on the control operation, wherein the state update information includes an ownership level of the target item, and the ownership level of the target item includes an ownership corresponding to the virtual character and/or an authority corresponding to the virtual space, and the authority of the virtual space includes an authority corresponding to the virtual character or an authority corresponding to the server.

### CROSS REFERENCES TO RELATED APPLICATIONS

The present application claims the priority of the Chinese patent application No. 202310076564.2 filed on Jan. 17, 2023 and the Chinese patent application No. 202311828445.4 filed on Dec. 27, 2023, for all purposes, the disclosure of which is incorporated herein by reference in its entirety as part of the present application.

### TECHNICAL FIELD

Embodiments of the present disclosure relate to a manipulation method and an apparatus for a virtual space, an electronic device, and a storage medium.

### BACKGROUND

With development of science and technology, users may realize various interactions with virtual space. Virtual Reality (VR for short) is a technology to create and experience a virtual world (also called a virtual space). Virtual reality generates a virtual environment by calculation, which is a kind of multi-source information (for example, the virtual reality may include a visual perception, an auditory perception, a tactile perception, a motion perception, etc.), and realizes an integrated and an interactive three-dimensional dynamic scene of the virtual environment and a simulation of entity behavior. Virtual reality immerses users in a simulated virtual reality environment, and realize applications in various virtual environments, such as map, game, video, education, medical care, simulation, collaborative training, sale, assistance in manufacturing, maintenance and repair.

Due to a particularity of the virtual world, the virtual world has various restrictions under different application scenarios, which will cause various problems, such as easy operation delay and poor immersion experience.

### SUMMARY

At least one embodiment of the present disclosure provides a manipulation method for a virtual space, the virtual space is created based on a server and at least one target terminal device communicatively connected with the server, at least one first virtual image and at least one second object manipulated by the first virtual image are arranged in the virtual space, the manipulation method includes: determining a virtual character corresponding to the target terminal device in the virtual space from the at least one first virtual image; and in response to a control operation on a target item in the at least one second object in the virtual space, acquiring state update information of the target item based on the control operation, in which the state update information includes an ownership level of the target item, and the ownership level of the target item includes an ownership corresponding to the virtual character and/or an authority corresponding to the virtual space, and the authority of the virtual space includes an authority corresponding to the virtual character or an authority corresponding to the server.

At least one embodiment of the present disclosure also provides a manipulation apparatus for a virtual space, the virtual space is created based on a server and at least one target terminal device communicatively connected with the server, at least one first virtual image and at least one second object manipulated by the first virtual image are arranged in the virtual space, the manipulation apparatus includes: a determination module, configured to determine a virtual character corresponding to the target terminal device in the virtual space from the at least one first virtual image; and an acquisition module, configured to acquire, in response to a control operation on a target item in the at least one second object in the virtual space, and acquire state update information of the target item based on the control operation, in which the state update information includes an ownership level of the target item, and the ownership level of the target item includes an ownership corresponding to the virtual character and/or an authority corresponding to the virtual space, and the authority of the virtual space includes an authority corresponding to the virtual character or an authority corresponding to the server.

At least one embodiment of the present disclosure provides an electronic device, which includes a processor and a memory, in which the memory stores a computer program, and the computer program, when executed by the processor, implements the manipulation method described in any one of the above examples.

At least one embodiment of the present disclosure provides a computer readable storage medium, in which the storage medium stores a computer program, and the computer program, when executed by a processing module, implements the manipulation method described in any one of the above examples.

### BRIEF DESCRIPTION OF THE DRAWINGS

In order to explain the embodiments of the present disclosure or the technical scheme in the prior art more clearly, the drawings needed to be used in the description of the embodiments or the prior art will be briefly introduced below. Obviously, the drawings in the following description are only some embodiments of the present disclosure, and other drawings may be acquired according to these drawings without creative work for person of ordinary skill in the art.

FIG. 1-FIG. 2 are schematic diagrams of the creation of a virtual space provided by some embodiments of the present disclosure;

FIG. 3 is a flowchart of a manipulation method for a virtual space provided by some embodiments of the present disclosure;

FIG. 4A is a flowchart of a manipulation method for a virtual space provided by other embodiments of the present disclosure;

FIG. 4B is a flowchart of an execution process of step S13 of the method in FIG. 4A;

FIG. 5 is a flow diagram of a virtual character requesting to pick up a target item provided by some embodiments of the present disclosure;

FIG. 6 is a schematic diagram of a virtual character requesting to pick up a target item provided by some embodiments of the present disclosure;

FIG. 7 is a schematic diagram of a virtual character requesting to pick up a target item provided by other embodiments of the present disclosure;

FIG. 8 is a schematic diagram of information interaction between multiple terminals for acquiring an ownership of a target object provided by some embodiments of the present disclosure;

FIG. 9 is a flowchart of verifying state update information in a manipulation method for a virtual space according to other embodiments of the present disclosure;

FIG. 10 is a flowchart of a manipulation method in an application scenario where items are in contact with each other according to other embodiments of the present disclosure;

FIG. 11 is a flowchart of a manipulation method in an application scenario where items are in contact with each other according to other embodiments of the present disclosure;

FIG. 12 is a schematic diagram of an execution process of verifying pending state update information provided by some embodiments of the present disclosure;

FIG. 13 is a schematic diagram of an execution process of verifying pending state update information provided by other embodiments of the present disclosure;

FIG. 14 is a schematic diagram of an execution process of verifying pending state update information provided by some embodiments of the present disclosure;

FIG. 15 is a flowchart of an execution process of step Y11 of the method in FIG. 9;

FIG. 16 is a block diagram of a manipulation apparatus for a virtual space provided by some embodiments of the present disclosure;

FIG. 17 is a schematic diagram of an application scenario provided by an embodiment of the present disclosure;

FIG. 18 is a first flowchart of a manipulation method for a virtual space provided by an embodiment of the present disclosure;

FIG. 19 is a second flowchart of a manipulation method for a virtual space provided by an embodiment of the present disclosure;

FIG. 20 is a schematic diagram of an application scenario provided by the present disclosure;

FIG. 21 is a schematic diagram of another application scenario provided by the present disclosure;

FIG. 22 is a structural block diagram of a manipulation apparatus for a virtual space provided by an embodiment of the present disclosure;

FIG. 23 is a structural schematic diagram of an electronic device provided by at least one embodiment of the present disclosure; and

FIG. 24 is a schematic diagram of a hardware structure of an electronic device provided by an embodiment of the present disclosure.

### DETAILED DESCRIPTION

The technical scheme in the embodiment of the present disclosure will be clearly and completely described below with reference to the accompanying drawings. Obviously, the described embodiments are only a part of embodiments of the present disclosure, but not the whole embodiments. Based on the embodiments in the present disclosure, all other embodiments acquired by person of ordinary skill in the art without creative work fall within the protection scope of the present disclosure.

Unless otherwise defined, all terms (including technical and scientific terms) used in the embodiments of the present disclosure have the same meaning as commonly understood by person of ordinary skill in the art to which the present disclosure belongs. It should also be understood that terms such as those defined in general dictionaries should be interpreted as having meanings consistent with their meanings in the context of the related art, and should not be interpreted in an idealized or extremely formal sense, unless explicitly defined by the embodiment of the present disclosure.

The terms “first”, “second” and similar terms used in the embodiments of the present disclosure do not indicate any order, quantity or importance, but are only used to distinguish different components. Similar terms such as “a”, “an” or “the” do not mean a quantity limit, but mean that there is at least one. Similarly, similar terms such as “comprising” or “including” mean that the elements or objects appearing before the term cover the elements or objects listed after the term and their equivalents, without excluding other elements or objects. Similar terms such as “connected” or “linked” are not limited to physical or mechanical connection, but may include electrical connection, whether direct or indirect, and similar terms such as “connected” or “linked” further include communication links.

Flowcharts are used in the embodiment of the present disclosure to explain the steps of the method according to the embodiment of the present disclosure. It should be understood that the steps before and after are not necessarily performed accurately in sequence. Instead, the various steps may be processed in reverse order or simultaneously. And other operations may also be added to these processes, or a step or steps may be removed from these processes.

The inventor of the present disclosure found that in the application scenario of virtual environments such as games, some games (such as fighting, Rts, Moba, etc.) generally use a physical synchronization model, that is, a consistent physical frame synchronization. For example, each client performs a partial delay buffering on the input (or calculates one more as a local prediction), and a server uniformly distributes input of each virtual character (i.e. player), and each player locally calculates physical results. Because of a consistent physical engine is adopted, the calculation results of each terminal are consistent, so a process of developing multiplayer games may be consistent with that of single-player games, and command-style input has a smaller amount of network. But for the virtual world, there will be following restrictions: for example, the virtual world does not use the consistent physical engine, because a maintenance cost of the consistent physical engine is high, which will have a great impact on development of other modules; for another example, the virtual world may be a Virtual Reality (VR) game, and the VR game can't buffer player's input. Failure to follow hand will make the player confused and lose the sense of immersion, which is difficult to solve.

The inventors of the present disclosure also found that some games (such as Fps, Moba, Mmorpg, etc.) commonly use a synchronization model of server-authoritative client prediction and rollback under the application scenario of virtual environments such as games. For example, all physical and logical operations are handled by the server, and all inconsistencies on the client will be rolled back. However, because there is a delay in sending instructions from the client to the server, the actual logic on the server will lag behind (for example, record it as frame x); a simulation prediction locally need to be made first for the leading n frames of the client (for example, record it as frame x+n) and the key data of the leading frames is cached for server verification.

For example, when an actual logical operation of the server is completed, a latest state data is sent to the client for verification (for example, record it as frame x+1); if a state predicted by the client is consistent with a verify data of the frame x+1, the cached data will be discarded and prediction will continue; if the state predicted by the client is inconsistent with a returned verify data of the frame x+1, the client needs to roll back all the data to the frame x+1, and re-predict from frame x+1 to frame x+1+n to update a presentation layer. In this way, the logic is clear, the data flow direction is single, and there is no delay in local operation, and the state is absolutely consistent and effective across multiple ternimals. However, this will also make the virtual world very challenging and restrictive, for example, for the state that needs to be rolled back, handling edge situations is more common and development difficulty is high. Moreover, the operation of rollback and prediction is a great challenge to a central processor, especially a physical operation simulation consumes a lot of computing power; in addition, the input in VR games may not use unitized instruction input, which greatly increases a difficulty of prediction and greatly reduces an accuracy of prediction; because the virtual world does not use the consistent physical engine, even when there is no error in the input and the prediction is accurate, physical calculation results will be inconsistent and will be rolled back frequently.

At least one embodiment of the present disclosure provides a manipulation method for a virtual space, the virtual space is created based on a server and at least one target terminal device communicatively connected with the server, in which at least one first virtual image and at least one second object manipulated by the first virtual image are arranged in the virtual space, the manipulation method includes: determining a virtual character corresponding to the target terminal device in the virtual space from the at least one first virtual image; and in response to a control operation on a target item in the at least one second object in the virtual space, acquiring state update information of the target item based on the control operation, in which the state update information includes an ownership level of the target item, and the ownership level of the target item includes the an ownership corresponding to the virtual character and/or an authority corresponding to the virtual space, and the authority of the virtual space includes an authority corresponding to the virtual character or an authority corresponding to the server.

At least one embodiment of the present disclosure also provides a manipulation apparatus corresponding to the manipulation method described above.

The manipulation method or the manipulation apparatus of the above embodiment of the present disclosure determines attribution of computation and maintenance of the corresponding item by determining the ownership level of the target item being controlled and manipulated in the virtual space, so that the interaction between physical items is stable, and physical interaction occurs without delay, thus avoiding observable jitter. The embodiment of the present disclosure reduces the performance requirements and restrictions on the central processor of the device suitable for running virtual space, reduces system cost, is beneficial to improving the player experience, and has a wide range of application scenarios.

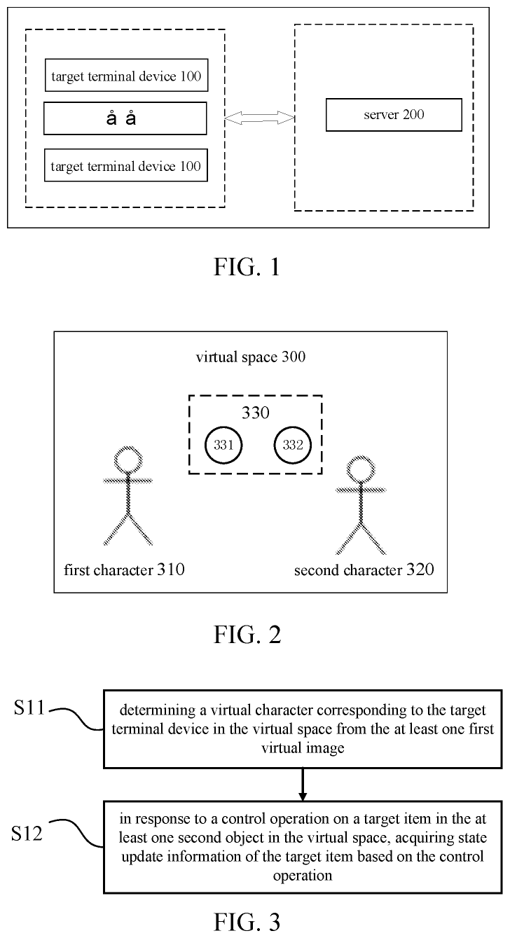

FIG. 1-FIG. 2 are schematic diagrams of the creation of a virtual space provided by some embodiments of the present disclosure. FIG. 3 is a flowchart of a manipulation method for a virtual space provided by some embodiments of the present disclosure.

For example, as shown in FIG. 1 and FIG. 2, the virtual space 300 of at least one embodiment of the present disclosure is created based on a server 200 and at least one target terminal device 100 (e.g., a plurality of target terminal devices 100 shown in FIG. 1, which is only exemplary) that is communicatively connected with the server 200.

In some embodiments, the target terminal device 100 may be referred to as a client with respect to the server 200. For example, the target terminal device 100 may be a wearable virtual reality device (VR device), and the wearable VR device may be a VR glasses, a VR helmet or a smart watch.

The embodiment of the present disclosure uses the wearable VR device to cooperate with the server 200, which makes the embodiment of the present disclosure have better experience and less restrictions in terms of operation convenience such as display and input mode, and information privacy guarantee.

Of course, this is only an example, and it is not a limitation of the present disclosure. For example, the wearable VR device of the embodiment of the present disclosure may also adopt other types of wearable VR devices that are intelligently designed and developed for daily wear by applying wearable technology and virtual reality technology, such as smart gloves and other wearable devices equipped with communication modules, which are not exhaustive or detailed here.

For example, as shown in FIG. 1 and FIG. 2, the virtual space 300 is provided with at least one first virtual image and at least one second object manipulated by the first virtual image. For example, the first virtual image may include a virtual character (also called a player). For example, the virtual character may include a first character 310 and a second character 320 shown in FIG. 2. For example, the second object may include a target item 330 shown in FIG. 2, and the target item 330 may include a first item 331 and/or a second item 332. Illustratively, the first item 331 and/or the second item 332 may be a sphere, for example, the first item 331 may be a ball A and the second item may be a ball B. Of course, this is only an example, and it is not limited by the embodiment of the present disclosure. The target item 330 and the first item 331 and/or the second item 332 of the embodiment of the present disclosure may be any physical object that may be created in the virtual space 300, which is not exhaustive or detailed here.

It should be noted that, for the convenience of description and understanding, the following examples are mainly explained by taking the first item 331 and/or the second item 332 as a ball, but the embodiment of the present disclosure does not limit the target item and the first item and/or the second item, and the embodiment of the present disclosure will not be exhaustive or repeated here.

It should also be noted that, in the embodiment of the present disclosure, the “first item” and the “second item” are intended to distinguish two target items in the virtual space, rather than being a restriction on the two items. In addition, the “first item” and/or the “second item” in the technical solutions of different embodiments in the present disclosure are not affected by each other. For example, the first item and the second item may be the same kind of items or different kinds of items. For example, in the case where the first item and the second item belong to the same kind of items, their sizes, shapes, structures, etc. may be the same or different, which is not limited by the embodiment of the present disclosure. In the embodiment of the present disclosure, when the target item determined in the virtual space only covers one item (such as the first item), the first item or the second item does not define any features of the item, or when the target item determined in the virtual space covers two items (such as the first item and the second item), the first item and the second item do not define any features of the two items. Therefore, this will not affect the protection scope of the embodiments of the present disclosure, and will not be exhaustive or detailed here.

In some embodiments, the first virtual image in the virtual space 300 may include not only virtual characters, but also non-player characters (NPC). Of course, this is only an example, and it is not the focus of the embodiment of the present disclosure, so it will not be repeated here.

For example, as shown in FIG. 1 to FIG. 3, the manipulation method for virtual space provided by some embodiments of the present disclosure at least includes step S11 and step S12.

Step S11, determining a virtual character corresponding to the target terminal device 100 in the virtual space 300 from the at least one first virtual image.

Step S12, in response to a control operation on a target item 330 in the at least one second object in the virtual space 300, acquiring state update information of the target item 330 based on the control operation.

In some embodiments, for step S12, the state update information of the target item 330 includes the ownership level of the target item 330, which includes an ownership corresponding to the virtual character and/or an authority corresponding to the virtual space 300, and the authority of the virtual space 300 includes an authority corresponding to the virtual character or an authority corresponding to the server 200.

The manipulation method of the above embodiment of the present disclosure determines attribution of computation and maintenance of the corresponding item by determining the ownership level of the target item being controlled and manipulated in the virtual space, so that the interaction between physical items is stable, and physical interaction occurs without delay, thus avoiding observable jitter. The embodiment of the present disclosure reduces the performance requirements and restrictions on the central processor of the device suitable for running virtual space, reduces system cost, is beneficial to improving the player experience, and has a wide range of application scenarios.

In some embodiments, the state update information of the target item 330 may further include a change order corresponding to the ownership level of the target item 330, which will not be repeated here for details, but may be found below.

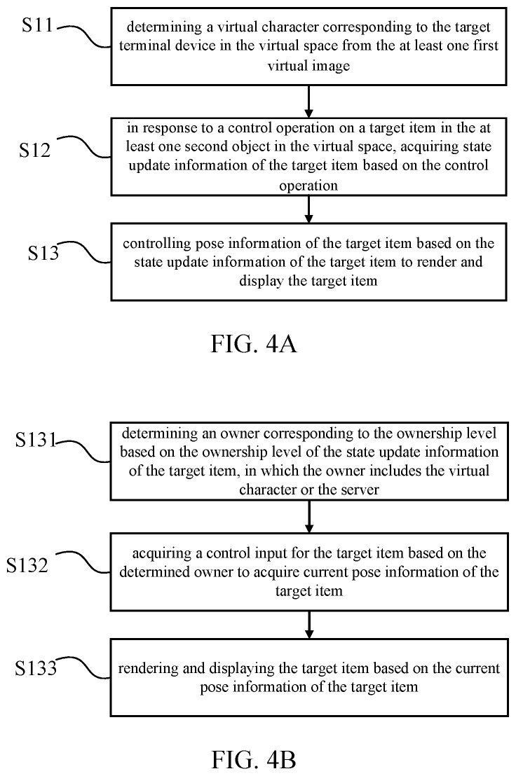

FIG. 4A is a flowchart of a manipulation method for a virtual space according to other embodiments of the present disclosure.

For example, as shown in FIG. 4A, the manipulation method provided by some embodiments of the present disclosure may further include the following process or step S13: controlling pose information of the target item 330 based on the state update information of the target item 330 to render and display the target item 330.

According to the embodiment of the present disclosure, the corresponding pose information may be controlled by the state update information of the target item, so that the interaction with the user may be accurately and effectively realized, and the immersive experience of the player may be improved.

The pose information in some embodiments of the present disclosure may be information of position and/or posture.

In some embodiments, an ownership priority of the ownership of the second object corresponding to the virtual character is greater than an ownership priority of the authority of the second object corresponding to the virtual character, and the ownership priority of the authority of the second object corresponding to the virtual character is greater than an ownership priority of the authority of the second object corresponding to the server 200.

In the embodiment of the present disclosure, the ownership corresponding to the virtual character of the second object means that the second object has been successfully picked up by the virtual character and has not been thrown out. For example, when the second object has the ownership corresponding to a virtual character, the virtual character is used to control or maintain at least one object feature information of the second object, that is, the virtual character is the owner corresponding to the ownership. For example, the virtual character controls or acquires the pose information of the second object. Of course, this is only exemplary and not a limitation of the present disclosure.

In the embodiment of the present disclosure, the authority of the second object corresponding to the virtual character means that the second object is not picked up by the virtual character, but the at least one object feature information of the second object is controlled or maintained by the virtual character, that is, the virtual character is the owner corresponding to the authority. For example, the virtual character controls or acquires the pose information of the second object that has just been thrown out and has not landed still. Of course, this is only exemplary and not a limitation of the present disclosure.

In the embodiment of the present disclosure, the authority of the second object corresponding to the server 200 means that the second object is not picked up by any virtual character, and the at least one object feature information of the second object is only controlled or maintained by the server 200, that is, the server 200 is the owner corresponding to the authority. For example, the server 200 acquires the pose information of the second object that has landed still. For example, the second object at rest on the ground and stands still may be an object that has been at rest all the time, or an object that is picked up by a virtual character and then thrown out and stands still for a certain period of time (which may be preset). Of course, this is only exemplary and not a limitation of the present disclosure.

In some embodiments, when the second object has the authority corresponding to the server 200, it may also be understood that the second object does not have the authority of any virtual character in the virtual space 300, that is, in some application scenarios (for example, when the second object stays on the ground in the virtual space for a long time and it is necessary to obtain the change order of the ownership in the state update information of the second object for application), it may also be understood that the second object has the ownership corresponding to the server 200. Of course, this is only exemplary and not a limitation of the present disclosure.

FIG. 4B is a flowchart of an execution process of step S13 of the method in FIG. 4A.

For example, as shown in FIG. 4B, an example of step S13 includes at least step S131˜to step S133.

Step S131, determining an owner corresponding to the ownership level based on the ownership level of the state update information of the target item 330, in which the owner includes the virtual character or the server 200.

Step S132, acquiring a control input for the target item 330 based on the determined owner to acquire current pose information of the target item 330.

Step S133, rendering and displaying the target item 330 based on the current pose information of the target item 330.

According to the embodiment of the present disclosure, by the owner of the ownership level in the state update information of the target item, the pose information of the target item can be effectively controlled and synchronized according to the control input of the owner, which is conducive to the control of the target item locally without jitter, and enhancing the immersive experience of the player.

For example, for step S132, in some embodiments, the above step S132 may further include the following process or step: in response to the determined owner being the virtual character, acquiring the control input for the target item 330 based on at least a portion of the target terminal device 100 corresponding to the determined owner to acquire the current pose information of the target item 330.

According to the embodiment of the present disclosure, based on the ownership level of the target item, effective local control and information synchronization of the pose information of the target item can be achieved according to the control input of the terminal device on the virtual character side, which is conducive to controlling the target item locally without jitter and improving the player's immersive experience.

For example, in step S132, when the determined owner is the server, the control of the pose information of the target item may be achieved by providing control input for the target item to the server by the user, which may be adjusted according to the actual situation. Because this is not the focus of the description of the embodiments of the present disclosure, it is not repeated here.

For example, the manipulation method provided by some embodiments of the present disclosure may further include the following processes or steps: in response to the determined owner corresponding to a first terminal device among the target terminal devices 100, rendering and displaying the target item 330 by the first terminal device based on the current pose information of the target item 330, and rendering and displaying the target item 330 by at least one other terminal device in the at least one target terminal device except the first terminal device based on the current pose information of the target item 330.

According to the embodiment of the present disclosure, based on the ownership level of the target item, the control input of the terminal device of the virtual character can not only achieve effective local control of the pose information of the target item, but also synchronize the information to achieve consistent computing or rendering results between the server and each client according to, so as to enhance the player's immersive experience.

In some embodiments, for step S132, the control input for the target item 330 may include input information corresponding to the control operation of the target item 330, for example, it may correspond to motion information of a control part of the first terminal device described below (for example, by using the first terminal device to provide input, the motion information corresponding to the control part may be acquired, so that the pose information corresponding to the target item may be acquired), which is not described in detail here.

In some embodiments, in the case where the second object has the authority corresponding to the virtual character but does not have the ownership of any virtual character, it may also be understood that the second object has the ownership corresponding to the server 200 in some application scenarios (for example, when the changing order of the ownership in the state update information of the second object needs to be acquired for application). Of course, this is only exemplary and not a limitation of the present disclosure.

In some embodiments, the ownership priority may be used to indicate the high or low level of ownership level that the second object has. For example, the greater the ownership priority, the higher the ownership level of the second object; conversely, the smaller the ownership priority, the lower the ownership level of the second object. For a manipulated second object, when it comes to choosing from two ownership levels, the higher ownership level will cover the lower ownership level.

For example, when a virtual character P picks up a ball A that has been static for a long time in the virtual space 300 (for example, the ownership level of the static ball A is the authority corresponding to the server 300), the ownership level of the ball A is changed to include the ownership corresponding to the virtual character P after the virtual character P picks up the ball successfully (for example, the ownership level of the ball A further includes the authority corresponding to the virtual character P, see below for details), that is, the ownership corresponding to the virtual character P of the ball A will cover the authority corresponding to the server 300 that the ball A had before.

For another example, in the case where the virtual character P just throws the ball A that has been picked up, and the ball A is still moving in the air and has not landed on the ground (for example, the ownership level of the ball A that is still moving in the air is the authority corresponding to the virtual character P but does not have the ownership corresponding to the virtual character P), if another virtual character Q picks up the ball A moving in the air at this time, the ownership level of the ball A is changed to include the ownership corresponding to the virtual character Q after the virtual character Q picks up the ball successfully (for example, the ownership level of the ball A further includes the authority corresponding to the virtual character Q, see below for details), that is, the ownership level of the ball A includes the ownership corresponding to the virtual character Q, which will cover the authority corresponding to the virtual character P that the ball A had before. Of course, this is only exemplary, and is not a limitation of the embodiments of the present disclosure.

It should be noted that, in the embodiment of the present disclosure, the greater the ownership priority means the higher the priority, but the representation of the ownership priority in the embodiment of the present disclosure is not limited, and it may be specified according to actual situation, for example, the higher the priority the higher the value of the ownership priority and the lower the priority the lower the value of the ownership priority, but the embodiment of the present disclosure is not limited to this, as long as it is in accordance with certain settings and/or laws, and the embodiment of the present disclosure will not be exhaustive and detailed here.

In some embodiments of the present disclosure, a pickup performed or acquired by a virtual character of a target item 330 means that the virtual character performs at least one interactive operation with the target item 330 that touches the target item 330 and keeps the target item 330 from detaching from a body part of the virtual character, such as the virtual character picking up the target item 330 from the ground, the virtual character holding the target item 330, or the virtual character patting the target item 330. Of course, this is only an example, and it is not a limitation of the present disclosure, so it is not exhaustive or detailed here. In some embodiments of the present disclosure, the virtual character releasing the target item 300 means that the virtual character stops or abandons the above-mentioned interactive operation, or the above-mentioned interactive operation is not completed, so that the target item 330 leaves or does not contact the body part of the virtual character.

The embodiment of the present disclosure may realize interaction matrix characteristics for the ownership and authority of the physical objects by controlling the ownership to be higher than the authority of the virtual character and the authority of the virtual character to be higher than the authority of the server, thus facilitating the realization effect of stable interaction between the physical objects and the physical interaction without delay.

In some embodiments, the manipulation method for the virtual space of some embodiments of the present disclosure further includes the following process or step: in response to the target item 330 not having the ownership of the virtual character and having the authority corresponding to the virtual character, controlling to keep the target item 330 still for a preset duration, and changing the ownership level in the state update information of the target item 320 to include the authority corresponding to the server 200.

It should be noted that the embodiment of the present disclosure does not limit the preset duration of stillness, and it may be freely adjusted according to the actual situation, which is not repeated here.

In some embodiments, the ownership of the target item 330 corresponding to the virtual character includes an identification number (ID) of the virtual character, the authority of the target item 330 corresponding to the virtual character includes the identification number (ID) of the virtual character, and the authority of the target item 330 corresponding to the server includes the identification number (ID) of the server. Therefore, the embodiment of the present disclosure is effective in accurately locating ownership and authority to the appropriate clients and/or servers, and the scheme is simple and effective, and the cost is low.

For example, for step S12, in some embodiments, in response to the determined virtual characters including a first character corresponding to a first terminal device in the at least one target terminal device 100 (for example, a first character 310 shown in FIG. 2) and a second character corresponding to a second terminal device in the at least one target terminal device 100 (for example, the second character 320 shown in FIG. 2). The above step S12 may further include the following process or step: in response to the first character 310 and/or the second character 320 providing a request (i.e., a pickup request) for picking up the target item 330, configuring the ownership level in the acquired state update information of the target item 330 to include the ownership level corresponding to the first character 310 or the ownership level corresponding to the second character 320.

According to the embodiment of the present disclosure, in the case where a virtual character intends to pick up an item, it is possible to achieve the effect that the local player has a latency-free item pickup operation feeling, and it may achieve the final consistent operation result between the server and each client, thus enhancing the player's experience.

For example, in some embodiments, the in response to the first character 310 and/or the second character 320 providing the request for picking up the target item 330, configuring the ownership level in the acquired state update information of the target item 330 to include the ownership level corresponding to the first character 310 or the ownership level corresponding to the second character 320, may include the following processes or steps: in response to the acquired ownership level of the target item 330 including the ownership corresponding to the first character 310, making the ownership level of the target item 330 further include the authority corresponding to the first character 310.

For another example, in some embodiments, in response to the first character 310 and/or the second character 320 providing the request for picking up the target item 330, configuring the ownership level in the acquired state update information of the target item 330 to include the ownership level corresponding to the first character 310 or the ownership level corresponding to the second character 320, may include the following processes or steps: in response to the acquired ownership level of the target item 330 including the ownership corresponding to the second character 320, making the ownership level of the target item 330 further include the authority corresponding to the second character 320.

In some embodiments, in the case where the target item 330 has the ownership and authority corresponding to the virtual character, the target item 330 dose not revert to having the authority of the server 200 no matter how long it takes. Of course, this is only exemplary and not a limitation of the present disclosure.

In some embodiments, the manipulation method for virtual space in some embodiments of the present disclosure further includes the following process or step: in the case that the state update information of the target item 330 is acquired and the ownership level in the state update information of the target item 330 includes the ownership level corresponding to the first character 310 or the ownership level corresponding to the second character 320, the second character 320 or the first character 310 is informed of the state update information of the target item 330. The embodiment of the present disclosure may realize the information unification between the server and the clients through the interaction between the server and the clients.

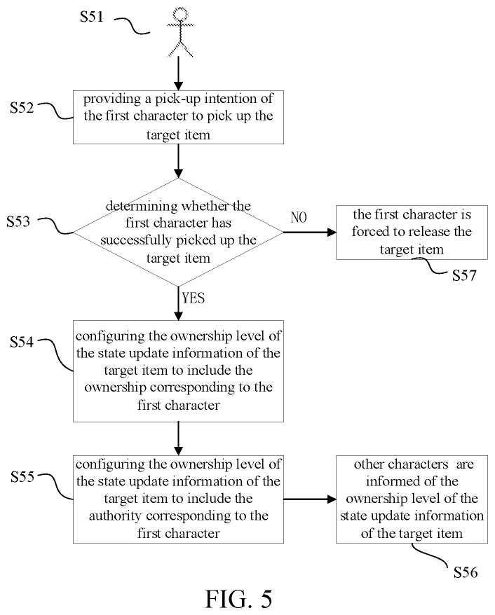

FIG. 5 is a flow diagram of a virtual character requesting to pick up a target item provided by some embodiments of the present disclosure.

For example, as shown in FIG. 5, the manipulation method for virtual space provided by some embodiments of the present disclosure at least includes step S51 to step S57.

Step S51, determining the first character 310 in the virtual space 300 corresponding to the first terminal device.

Step S52, providing a pick-up intention of the first character 310 to pick up the target item 330.

Step S53, determining whether the first character 310 has successfully picked up the target item 330; if yes, that is, the first character 310 succeeds in picking up the target object 330, go to step S54; if not, that is, the first character 310 fails in picking up the target object 330, then the process go to step S57.

Step S54, configuring the ownership level of the state update information of the target item 330 to include the ownership corresponding to the first character 310.

Step S55, based on the ownership level of the state update information of the target item 330 including the ownership corresponding to the first character 310, configuring the ownership level of the state update information of the target item 330 to include the authority corresponding to the first character 310.

Step S56, in response to the ownership level of the target item 330 including the ownership and authority corresponding to the first character 310, other characters (that is, other players, for example, other players are other characters corresponding to at least one other terminal device except the first terminal device in the at least one target terminal device 100 in the virtual space 300) are informed of the ownership level of the state update information of the target item 330.

Step S57, the first character 310 is forced to release the target item 330.

In some embodiments, for step S52, providing the pick-up intention of the first character 310 to pick up the target item 330 may mean that the first character 310 sends a pick-up request for picking up the target item 330 to the server 200. For example, providing the pick-up request for picking up the target item 330 may be realized by operating the control part of the first terminal device (for example, by pressing the trigger key of the hand controller of the VR device). Of course, this is only exemplary and not a limitation of the present disclosure.

In some embodiments, at least one of step S51, step S52 and step S57 is configured to be executed by the target terminal device 100 (for example, the first terminal device corresponding to the first character 310), at least one of step S53, step S54 or step S55 is configured to be executed by the server 200, and step S56 is configured to be executed by other terminal devices corresponding to other characters. Of course, this is only exemplary, and the embodiment of the present disclosure does not limit the execution subject of each step, so it is not exhaustive or detailed here.

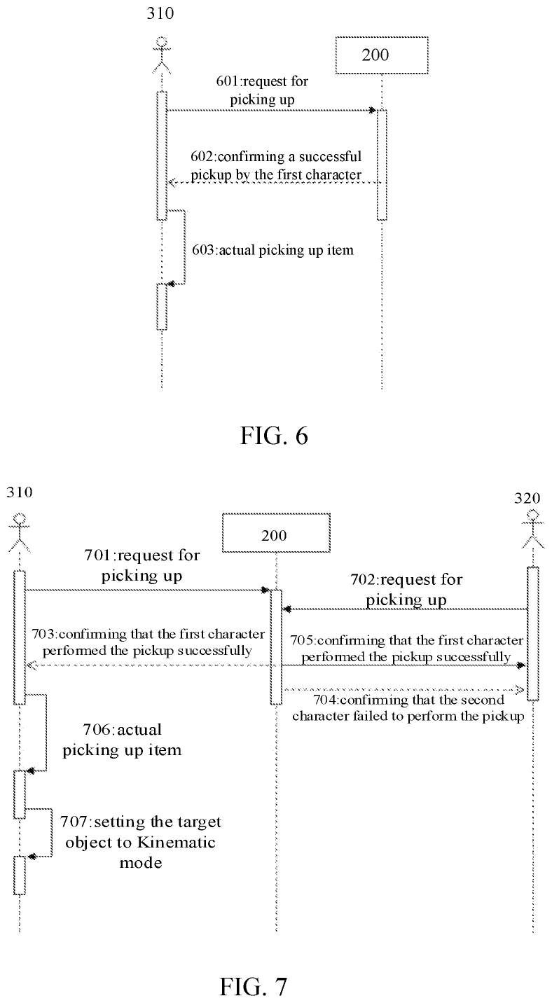

FIG. 6 is a schematic diagram of a virtual character requesting to pick up a target item provided by some embodiments of the present disclosure.

In some embodiments, when the first character 310 sends a request for picking up the target item 330 to the server 200 alone, the ownership level in the state update information of the target item 330 includes the ownership level corresponding to the first character 310. For example, when the first character 310 successfully picks up the target item 330, the ownership level of the target item 330 includes the ownership corresponding to the first character 310.

For example, as shown in FIG. 6, the first character 310 sends a pick-up request for picking up the target item 330 to the server 200 (i.e., the interaction 601 shown in FIG. 6, for example, the pick-up request may also indicate the pick-up intention of the first character 310 to pick up the target item 330). If the server 200 returns a response to the first character 310 confirming a successful pickup by the first character (i.e., the interaction 602 shown in FIG. 6), the first character 310 performs the actual picking up of the item (i.e., the operation 603 shown in FIG. 6) based on the response confirming the successful pickup by the first character. After the target object 330 is successfully picked up by the first character 310, the target item 330 has the ownership corresponding to the first character 310, and in the case that the target item 330 has the ownership corresponding to the first character 310, the target item 330 also has the authority corresponding to the first character 310.

Similarly, for example, when the second character 320 provides the request for picking up the target item 330 to the server 200 alone, the ownership level in the state update information of the target item 330 includes the ownership level corresponding to the second character 320. For example, when the second character 320 successfully picks up the target item 330, the ownership level of the target item 330 includes the ownership corresponding to the second character 320.

FIG. 7 is a schematic diagram of a virtual character requesting to pick up a target item provided by other embodiments of the present disclosure, and FIG. 7 is an example diagram showing two characters grabbing the ownership of a target item.

In some embodiments, as shown in FIG. 7, the first character 310 sends a pick-up request for picking up the target item 330 to the server 200 (i.e. interaction 701 shown in FIG. 7, for example, the pick-up request may also indicate the pick-up intention that the first character 310 wants to pick up the target item 330) and the second character 320 also sends a pick-up request for picking up the target item 330 to the server 200 (i.e. interaction 702 shown in FIG. 7), the server 200 returns a response to the first character 310 confirming that the first character performed the pickup successfully (i.e., interaction 703 shown in FIG. 7), returns a response to the second character 320 (i.e., an interaction 704 shown in FIG. 7) confirming that the second character failed to perform the pickup and sends a feedback result to the second character 320 (i.e., an interaction 705 shown in FIG. 7) confirming that the first character performed the pickup successfully. And, the first character 310 executes performs the actual picking up of the item based on the response confirming that the first character picked up successfully (i.e., operation 706 shown in FIG. 7). After the target object 330 is successfully picked up by the first character 310, the target item 330 has the ownership corresponding to the first character 310, and the target item 330 also has the authority corresponding to the first character 310. For example, after the second character 320 receives the response confirming that the second character failed to pick up and a feedback result confirming that the first character picked up successfully, the second character 320 is forced to release the target item 330.

The embodiment of the present disclosure may achieve the effect that the player has the feeling of picking up items without delay under the situation that a plurality of virtual characters intend to snatch objects, realize the final consistent operation result between the server and each client, and improve the player's experience.

The embodiment of the present disclosure may be applied to the application scene of the virtual space with a large number of people, and is also well applied to the situation of low network bandwidth consumption, and has a wide application prospect.

For example, in the example of FIG. 7, after the first character 310 performs a successful pick-up, the target item 330 may also be set to a Kinematic mode. Of course, this is only an example, not a limitation of the embodiment of the present disclosure, and the setting operation may be freely adjusted according to the actual situation, which is not repeated here.

For example, in the example of FIG. 7, the first character 310 provides a pick-up request to the server 200 before the second character 320, for example, the user corresponding to the first character 310 presses the trigger key of the hand controller of the VR device earlier to provide an intention to pick up the target item 330, so that the server 200 may confirm that the target item 330 is picked up by the first character. Of course, this is only exemplary, and is not a limitation of the embodiments of the present disclosure.

In some embodiments, the manipulation method for virtual space of some embodiments of the present disclosure further includes the following process or step: acquiring the target item 330 by acquiring an item identification number (i.e., the item ID) of the target item 330.

In some embodiments, the manipulation method for virtual space of some embodiments of the present disclosure further includes the following process or step: in response to the first terminal device in the target terminal device 100 being a wearable virtual reality device (VR device) and the wearable virtual reality device including a control part, synchronizing motion information of the control part of the first terminal device to the server 200 and/or at least one other terminal device except the first terminal device in the at least one target terminal device 100. For example, the control part of the wearable virtual reality device is configured to control the control operation of the virtual character corresponding to the first terminal device on the target item 330, and the motion information of the control part corresponds to the control input of the first terminal device. For example, the control part of the wearable virtual reality device includes, but is not limited to, a hand controller, and the embodiment of the present disclosure does not limit or repeat this.

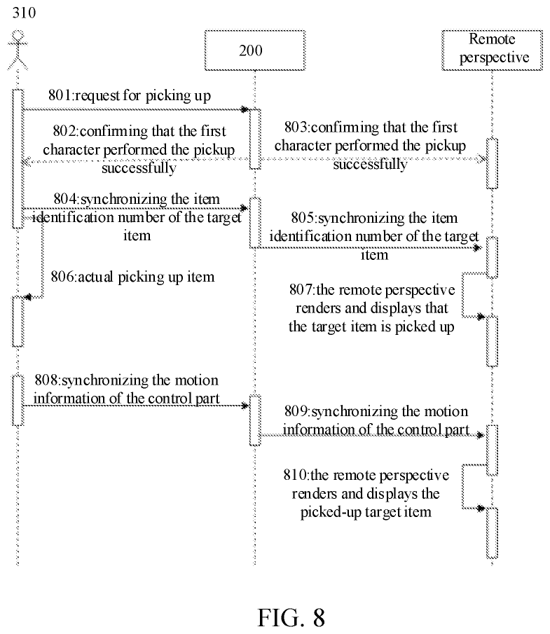

FIG. 8 is a schematic diagram of information interaction between multiple terminals for acquiring ownership of a target item provided by some embodiments of the present disclosure. In the example of FIG. 8, the first character 310 successfully picks up the target item 330 and owns the ownership of the target item 330, and the remote perspective represents the remote perspective of the first character 310 by other characters (i.e. other players) other than the first character. The interaction 801, the interaction 802, the interaction 803 and the operation 806 in the example of FIG. 8 mayrefer to the above-mentioned examples of FIG. 6 and FIG. 7, and will not be repeated here.

For example, in the example of FIG. 8, a pick-up request sent by the first character 310 to the server 200 includes the item identification number of the target item 330.

For example, as shown in FIG. 8, the first character 310 may also separately synchronize the item identification number of the target item 330 with the server 200. For example, the first character 310 may synchronize the item identification number of the target item 330 through a component (such as a web crawler) provided in the VR device (as shown in the interaction 804 in FIG. 8). Of course, this is only exemplary, and is not a limitation of the embodiments of the present disclosure.

For example, as shown in FIG. 8, the server 200 synchronizes the item identification number of the target item 330 with other characters in the remote perspective (as shown in the interaction 805 in FIG. 8). Thus, other players in the remote perspective may render that the target item 330 is picked up based on the item identification number of the target item 330 (as shown in the operation 807 in FIG. 8).

For example, as shown in FIG. 8, the first character 310 also synchronizes the motion information of the control part to the server 200 and other characters in the remote perspective (as shown in the interaction 808 and the interaction 809 in FIG. 8). For example, other characters in the remote perspective may also acquire the pose information (not shown in figure) of the target item 330 based on the synchronized motion information of the control part. For example, the first character 310 may synchronize the motion information of the control part of the target item 330 through a component (such as a network converter) provided in the VR device. Of course, this is only exemplary, and is not a limitation of the embodiments of the present disclosure.

For example, in the example of FIG. 8, other characters from in the remote perspective may render and display the picked-up target item 330 (as shown in the interaction 810 in FIG. 8) based on the synchronized motion information of the control part and a corresponding specified offset (for example, an offset between the target item 330 and the body part operating the above control part). For example, the specified offset includes the deviation of position and rotation, and the specified offset may be determined in advance. Of course, this is only an example, and it is not a limitation of the present disclosure, and it may be freely adjusted according to the actual situation, because it is not the key point to be described in the embodiment of the present disclosure, so it is not repeated here.

According to the embodiment of the present disclosure, by adopting a wearable VR device to cooperate with the server 200, this makes the present disclosure a better experience and less restrictive in terms of the ease of operation of the display, input method, etc., as well as in terms of the assurance of the privacy of information. The embodiment of the present disclosure control to make the local virtual character terminal to synchronize information with the server and other virtual character terminals, which is not only conducive to controlling the target object locally without jitter, but also helps to achieve consistent operation results or rendering results between the server and each client, and reduces the complexity of the scheme and the system cost.

In some embodiments, the control part of the VR device may be a hand controller. For example, other characters in the remote perspective may render and display the picked target item 330 based on the synchronized motion information of the control part and the specified offset between the target item 330 and the hand. Of course, this is only exemplary, and is not a limitation of the embodiments of the present disclosure.

In some embodiments, in response to the state update information of the target item 330 further including a change order corresponding to the ownership level of the target item 330, the manipulation method for the virtual space 300 provided by some embodiments of the present disclosure further includes the following processes or steps: determining pending state update information of the target item 330 to be verified based on the state update information of the target item; comparing a change order in the pending state update information with a change order in current target state information of the target item 330 to verify the pending state update information; acquiring a verification success result in response to the pending state update information being verified as effective state update information; and acquiring a verification failure result in response to the pending state update information being verified as ineffective state update information.

The embodiment of the present disclosure may update the state information of an item in time, effectively and accurately by using the change order in the state update information of the object, which is beneficial to improving the player's experience.

In some embodiments, the change order of the state update information of the target item 330 represents a characterization parameter of the number of times the ownership level of the target 330 has been updated based on the control operation on the target item 330, that is, the change order may reflect the sequence of the stage in which the state of the target item 330 is located.

For example, in the virtual space 300, when a ball O, as a target item, initially stands still on the ground for a period of time and is not picked up by any character, the ownership level in the current state update information of the ball O includes the authority corresponding to the server 200, and the change order of the authority and the change order of the ownership in the current state update information of the ball O are recorded as 0.

For the first time, the ball O is picked up from the ground by a virtual character M1, then the ownership level in the state update information of the ball O will change to include the ownership and the authority corresponding to the virtual character M1 (for example, the ownership and the authority both correspond to the ID of the virtual character M1or have the ID of the virtual character M1), and the change order of the ownership in the state update information of the ball O will increase (for example, increase to 1) and the change order of the authority will increase (for example, increase to 1), which may be recorded as a first stage.

For the second time, the ball O is thrown out by the virtual character M1 and lands on the ground and stands still for a period of time. At this time, the ownership level in the state update information of the ball O changes to include the authority corresponding to the server 200, so the change order of the authority in the current state update information of the ball O will increase (for example, increase to 2) and the change order of the ownership will increase (for example, increase to 2), which may be recorded as a second stage.

It should be noted that the embodiment of the present disclosure does not limit the specific form and mode of the change order of the state update information, as long as it may reflect the amount of times that the ownership level has been updated. For example, after the target item 330 is controlled and operated again, the corresponding change order may be increased from x to x+1 or from x to x+2 at one time, which is not limited by the embodiment of the present disclosure, as long as it follows the set rules, which will not be described here.

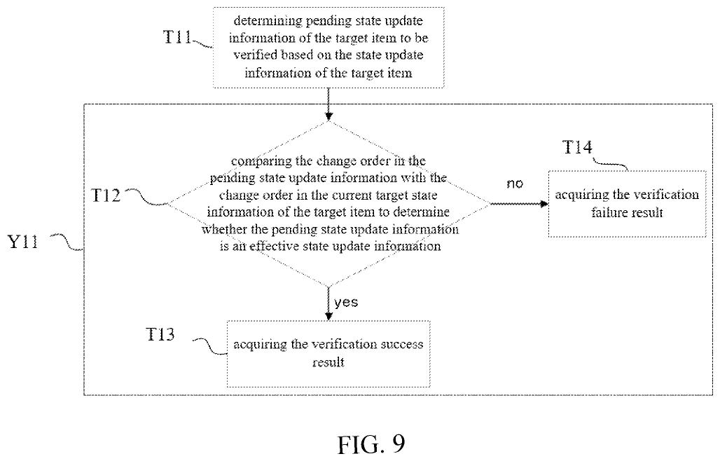

FIG. 9 is a flowchart of verifying state update information in a manipulation method for a virtual space according to other embodiments of the present disclosure.

For example, as shown in FIG. 9, the manipulation method for virtual space provided by some embodiments of the present disclosure at least further includes step T11 to step T14.

Step T11, determining pending state update information of the target item 330 to be verified based on the state update information of the target item 330.

Step T12, comparing the change order in the pending state update information with the change order in the current target state information of the target item 330 to verify the pending state update information.

For example, in step T12, for verifying the pending state update information, it may be the state update information including determining whether the pending state update information is an effective state update information; if yes, that is, the pending state update information is the state update information of effective update, then go to step T13; if not, that is, the pending state update information is verified as the state update information of ineffective update, then go to step T14.

Step T13, acquiring the verification success result.

Step T14, acquiring the verification failure result.

In some embodiments, step T12, step T13, and step T14 in FIG. 9 mayall be regarded as part of verifying the pending state update information (for convenience of description, this may be referred to as step Y11).

In some embodiments, the current target state information of the target item 330 may represent the latest state update information currently available in the whole system (including the server 200 and the target terminal device 100). For example, the current target state information of the target item 330 may be a latest state information that the server 200 is synchronized with all other terminal devices, or the latest state update information that is known by at least one target terminal device side but has not been synchronously informed to the server 200. This is only an example, not a limitation of the embodiment of the present disclosure, and it may be freely adjusted according to the actual situation, so it is not repeated here.

In some embodiments, the effective state update information indicates that the pending state update information may be accepted as the latest state update information at present, and the ineffective state update information indicates that the pending state update information may not be accepted as the latest state update information at present, that is, the previous latest state update information before is maintained.

In some embodiments, in the example of the ball O mentioned above, when the ball O reaches the second stage, the network of a virtual character M2 has a problem causes the information available to virtual character M2 to remain in the first stage of the ball O (for example, the change order of the ownership and authority of the state update information of the ball O that the virtual character M2 knows is 1). The network of another virtual character M3 is normal, the virtual character M3 may normally know that the ball O has gone through the first stage and the second stage (for example, the change order of the ownership and authority of the state update information of the ball O that the virtual character M3 knows at this time is both 2). Therefore, it is assumed that when the ball O goes through a third stage, if the virtual character M2 and the virtual character M3 conflict with the latest state update information of the ball O, the server 200 will accept the information provided by the virtual character M3, because the change order of ownership and authority in the information provided by the virtual character M3 is higher. Of course, this is only an example, not a limitation of the embodiment of the present disclosure, and it may be freely adjusted according to the actual situation, so it is not repeated here.

For example, for step S12, in some embodiments, in response to the target item 330 including a first item (e.g., a first item 331) and a second item (e.g., a second item 332), the above step S12 may further include the following processes or steps (e.g., step S121): in response to the first item 331 contacting with the second item 332, acquiring the state update information of the first item 331 and/or the state update information of the second item 332.

The embodiment of the present disclosure may realize physical interaction without delay when an object contacts with other objects, and there will be no observable jitter, which is beneficial to improving the player experience and has a wide range of application scenarios.

For example, for step S12, in some embodiments, in response to the determined virtual characters comprising a first character corresponding to a first terminal device in at least one target terminal device 100 (for example, the first character 310 shown in FIG. 2) and a second character corresponding to a second terminal device in at least one target terminal device 100 (for example, the second character 320 shown in FIG. 2). The above step S121 may further include the following process or step (for example, step S121a): in response to the first item 331 having the ownership corresponding to the first character 310 and the second item 332 having the authority of the virtual space 300, controlling to make the first item 331 contact with the second item 332, so that the ownership level of the second item 332 is changed to include the authority corresponding to the first character 310, so as to acquire the state update information of the second item 332.

According to the embodiment of the present disclosure, based on the characteristics of ownership and authority set by the control, it is possible to realize that in a scenario in which an object is picked up and then comes into contact with other objects, the physical interaction occurs without delay and without observable jitter, which is conducive to enhancing the player experience.

For example, for step S121a, in some embodiments, in response to the ownership level of the second item 332 being changed to include the authority corresponding to the first character 310 and the state update information of the second item 332 is acquired correspondingly, the state update information corresponding to the second item 332 is used as the pending state update information to be verified to verify the pending state update information, for example, the current target state information of the target item 330 includes the current target state information of the second item 332. For example, in response to acquiring the verification success result, other characters in the virtual space 330 corresponding to at least one other terminal device except the first terminal device in the at least one target terminal device 100 are informed that the ownership level of the second item 332 is changed to include the authority corresponding to the first character 310 and the pose information of the second item 332 is synchronized with other characters; for example, in response to acquiring the verification failure result, the current target state information is used as the updated state update information of the second item 332.

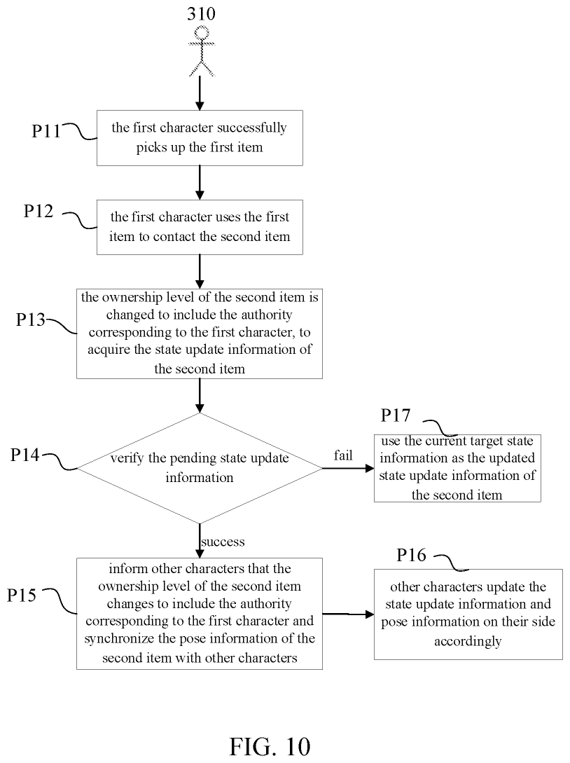

FIG. 10 is a flowchart of a manipulation method in an application scenario where items are in contact with each other according to other embodiments of the present disclosure.

For example, as shown in FIG. 10, the manipulation method for the virtual space in some embodiments of the present disclosure includes step P11 to step P17.

Step P11, the first character 310 successfully picks up the first item 331.

For example, in step P11, the first item 331 has the ownership and the authority corresponding to the first character 310.

Step P12, the first character 310 uses the first item 331 to contact the second item 332.

For example, in step P12, the second item 332 has the authority of the virtual space 300, and the second item 332 does not have the ownership of any virtual character in the virtual space 300. Of course, this is only exemplary and not a limitation of the present disclosure.

Step P13, the ownership level of the second item 332 is changed to include the authority corresponding to the first character 310, to acquire the state update information of the second item 332.

For example, in step P13, the change in the ownership level of the second object 332 to include the authority corresponding to the first character 310 may mean that the ownership level of the second item 332 is changed from the previous authority corresponding server 200 to the authority corresponding to the first character 310, or may mean that the ownership level of the second item 332 is changed from the authority corresponding to other virtual characters to the authority corresponding to the first character 310. Of course, this is only exemplary and not a limitation of the present disclosure.

For example, in step P13, the state update information of the second item 332 further includes the change order of the second item 332. For example, when the ownership level of the second item 332 is modified, the change order of the second item 332 in the state update information will also increase (see below for details).

Step P14, the state update information of the second item 332 is used as the pending state update information to be verified to verify the pending state update information. If the verification is successful, the verification success result is acquired, and the process go to step P15; if the verification fails, the verification failure result is acquired, and the process go to step P17.

Step P15, inform other characters (that is, other characters in the virtual space 330 corresponding to the at least one other terminal device except the first terminal device in the at least one target terminal device 100) that the ownership level of the second item 332 changes to include the authority corresponding to the first character 310 and synchronize the pose information of the second item 332 with other characters.

For example, in step P15, other characters may include the second character 320, or other virtual characters except the first character 310 and the second character 320, which is not limited by the embodiment of the present disclosure, and may be determined according to the actual application, which is not repeated here.

Step P16, after informing other characters that the ownership level of the second item 332 has changed and synchronizing the pose information of the second item 332, other characters update the state update information and pose information on their side accordingly.

Step P17, use the current target state information as the updated state update information of the second item 332.

In some embodiments, at least one of step P11, step P12, step P13 or step P17 is configured to be executed by the target terminal device 100 corresponding to the first character 310 (for example, the first terminal device), at least one of step P14 and step P15 is configured to be executed by the server 200, and step P16 is configured to be executed by other terminal devices corresponding to other characters. Of course, this is only exemplary, and the embodiment of the present disclosure does not limit the execution subject of each step, so it is not exhaustive or detailed here.

For example, for step S12, in some embodiments, in response to the determined virtual character including the first character corresponding to the first terminal device in at least one target terminal device 100 (for example, the first character 310 shown in FIG. 2) and the second character corresponding to the second terminal device in at least one target terminal device 100 (for example, the second character 320 shown in FIG. 2). The above step S121 may further include the following processes or steps (for example, step S121b): in response to the first item 331 losing the ownership corresponding to the first character 310 and the first item 331 having the authority corresponding to the first character 310, controlling to make the first item 331 contact with the second item 332, and acquiring the ownership level of the first item 331 and/or the ownership level of the second item 332 to acquire the state update information of the first item 331 and/or the state update information of the second item 332.

According to the embodiment of the present disclosure, based on the characteristics of ownership and authority set by the control, it is possible to realize that in a scenario in which an object is thrown by the player and come into contact with other items, the physical interaction occurs without delay and without observable jitter, which is conducive to enhancing the player experience.

For example, for step S121b, in some embodiments, the controlling to make the first item 331 contact with the second item 332, and acquiring the ownership level of the first item 331 and/or the ownership level of the second item 332, including at least one of the following:
(b1) Controlling to make the first item 331 contact with the second item 332, and controlling the ownership level of the first item 331 to be changed to include the authority corresponding to the second character 320 in response to the second item 332 having the ownership corresponding to the second character 320 (i.e., the owner of the detected second item 332 as described below).
(b2) Controlling to make the first item 331 contact with the second item 332, and in response to the second item 332 having the authority corresponding to the server 200, controlling to change the ownership level of the second item 332 to include the authority corresponding to the first character 310.
(b3) Controlling to make the first item 331 contact with the second item 332, and in response to the second item 332 having the authority corresponding to the second character 320, controlling to keep the ownership level of the second item 332 and the ownership level of the first item 331 unchanged.

For example, for step S121b, in some embodiments, in response to the controlling the ownership level of the second item 332 to be changed to include the authority corresponding to the first character 310 and acquiring the state update information of the second item 332, the state update information corresponding to the second item 332 is used as the pending state update information to be verified to verify the pending state update information, for example, the current target state information of the target item 330 includes the current target state information of the second item 332. For example, in response to acquiring the verification success result, other characters in the virtual space 300 corresponding to at least one other terminal device except the first terminal device in the at least one target terminal device 100 are informed that the ownership level of the second item 332 is changed to include the authority corresponding to the first character 310 and the pose information of the second item 332 is synchronized with other characters; for example, in response to acquiring the verification failure result, the current target state information of the second item 332 is used as the updated state update information of the second item 332.

For example, for step S121b, in other examples, in response to controlling the ownership level of the first item 331 to be changed to include the authority corresponding to the second character 320, and acquiring the state update information corresponding to the first item 331, the state update information corresponding to the first item 331 is used as the pending state update information to be verified to verify the pending state update information. For example, the current target state information of the target item 330 includes the current target state information of the first item 331. For example, in response to acquiring the verification success result, other characters in the virtual space 300 corresponding to at least one other terminal device except the first terminal device in the at least one target terminal device 100 are informed that the ownership level of the first item 331 is changed to include the authority corresponding to the second character 320 and the pose information of the first item 331 is synchronized with other characters; for example, in response to acquiring the verification failure result, the current target state information of the first item 331 is used as the updated state update information of the first item 331.

According to the embodiment of the present disclosure, based on the characteristics of ownership and authority set by the control, it is possible to achieve timely, effective and accurate updating of the state information of the corresponding item in different situations in scenarios where the item is thrown by the player and come into contact with other objects, making it possible to realize the occurrence of physical interactions without delay and without observable jitter, which is conducive to the enhancement of the player's experience.

It should be noted that for the above step S121b, in the case that the second item 332 has the authority corresponding to the second character 320, the embodiment of the present disclosure is not limited to controlling the ownership level of the second item 332 and the ownership level of the first item 331 to remain unchanged, but also may set and change the ownership level of the second item 332 and/or the ownership level of the first item 331 according to the actual situation, which is not the key point to be described in the embodiment of the present disclosure, and will not be repeated here.

The embodiment of the present disclosure, through the ingenious design of keeping the original authority of two items having only corresponding virtual characters unchanged when they are in contact with each other, not only can ensure the player's sense of experience, but also avoid a series of problems caused by switching, and the program is simple and effective.

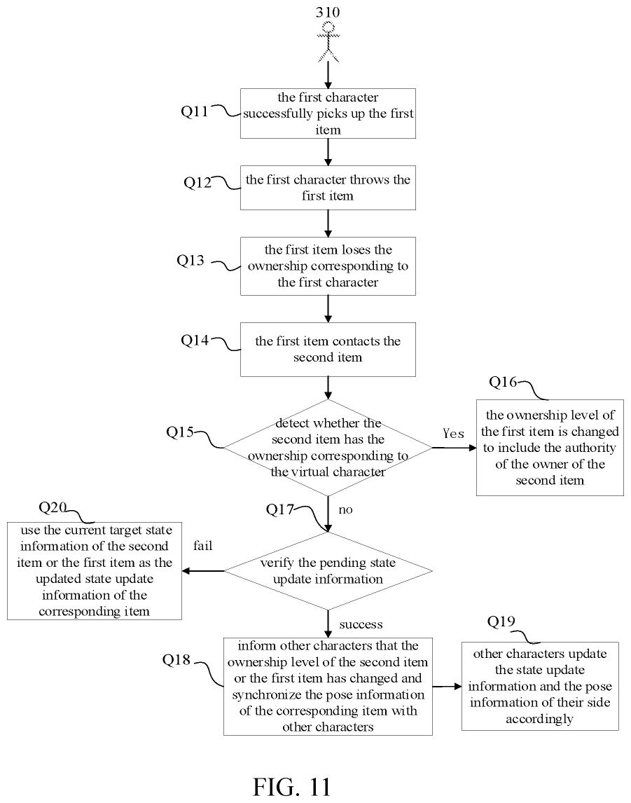

FIG. 11 is a flowchart of a manipulation method in an application scenario where items are in contact with each other according to other embodiments of the present disclosure.

For example, as shown in FIG. 11, the manipulation method for the virtual space in some embodiments of the present disclosure includes step Q11 to step Q20.

Step Q11, the first character 310 successfully picks up the first item 331.

For example, in step Q11, the first item 331 has the ownership and the authority corresponding to the first character 310.

Step Q12, the first character 310 throws the first item 331.

For example, in step Q12, the first character 310 throwing the first item 331 indicates that the first item 331 is no longer grabbed by the first character 310.

Step Q13, the first item 331 loses the ownership corresponding to the first character 310.

Step Q14, the first item 331 contacts the second item 332.

Step Q15, detect whether the second item 332 has the ownership corresponding to the virtual character (that is, detect whether the second item 332 has the corresponding owner); if yes, go to step Q16; if not, go to step Q17.

Step Q16, if it is detected that the owner of the second item 332 is the second character (such as the second character 320, where the second character 320 may represent any character different from the first character 310), the ownership level of the first item 331 is changed to include the authority of the owner (such as the second character 320) of the second item 332.

Step Q17, determine the pending state update information to be verified, and verify the pending state update information; if the verification is successful, the verification success result is acquired, and the process go to step Q18; if the verification fails, the verification failure result is acquired, and the process go to step Q20.

Step Q18, inform other characters (that is, other characters in the virtual space 330 corresponding to at least one other terminal device except the first terminal device in the at least one target terminal device 100) that the ownership level of the second item 332 or the first item 331 has changed and synchronize the pose information of the corresponding item with other characters.

For example, if the determined pending state update information to be verified in step Q17 is the state update information of the second item 332, then in step Q18, other characters are informed of the change of the ownership level of the second item 332 and the pose information of the second item 332 is synchronized.

For example, if the determined pending state update information to be verified in step Q17 is the state update information corresponding to the first item 331, then in step Q18, other characters are informed of the change of the ownership level of the first item 331 and the pose information of the first item 331 is synchronized.

Step Q19, after informing other characters that the ownership level of the second item 332 or the first item 331 has changed and synchronizing the pose information of the corresponding item, other characters update the state update information and the pose information of their side accordingly.

Step Q20, use the current target state information of the second item 332 or the first item 331 as the updated state update information of the corresponding item.

For example, if the information informing other characters in step Q18 includes the change of the ownership level of the second item 332, the current target state information of the second item 332 is used as the updated state update information of the second item 332 in step Q20.

For example, if the information informing other characters in step Q18 includes the change of the ownership level of the first item 331, the current target state information of the first item 331 is taken as the updated state update information of the first item 331 in step Q20.

In some embodiments, at least one of step Q11, step Q12, step Q14 or step Q20 is configured to be executed by the target terminal device 100 (for example, the first terminal device) corresponding to the first character 310, at least one of step Q13, step Q17 or step Q18 is configured to be executed by the server 200, and at least one of step Q16 or step Q19 is configured to be executed by other terminal devices corresponding to other characters. The server 200 may be configured to perform and realize step Q15, and the first terminal device may also be configured to perform and realize step Q15. Of course, this is only exemplary, and the embodiment of the present disclosure does not limit the execution subject of each step, so it is not exhaustive or detailed here.

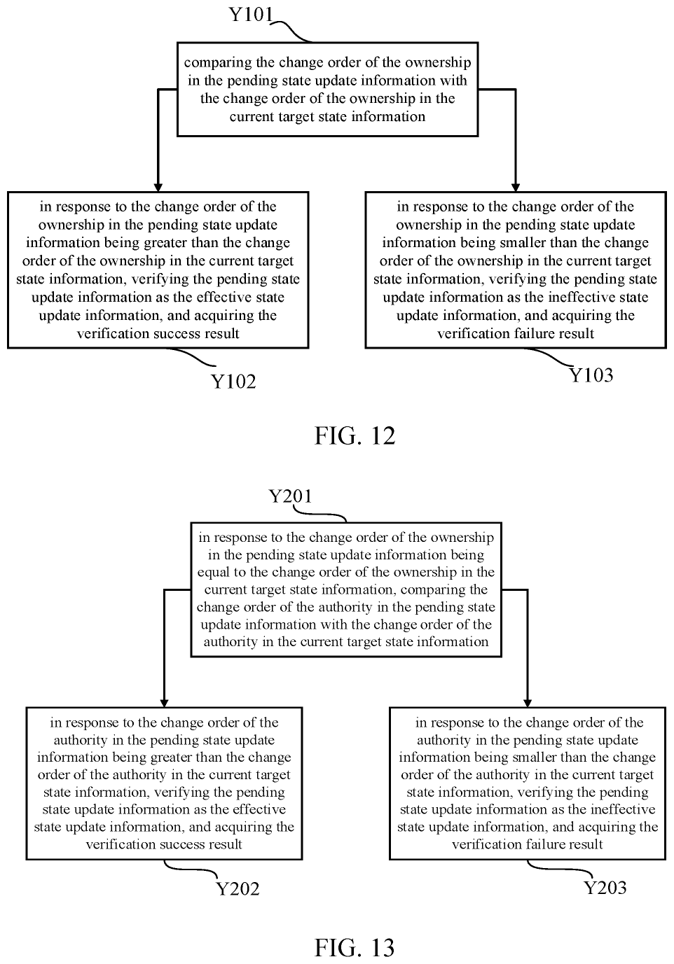

FIG. 12 is a schematic diagram of an execution process of verifying the pending state update information provided by some embodiments of the present disclosure.

For example, for step Y11, in some embodiments, the change order in the pending state update information in the above step Y11 is configured to be compared with the change order in the current target state information of the target item 330 to verify the pending state update information, which may further include at least one of steps in step Y101 to step Y103 as shown in FIG. 12.

Step Y101, comparing the change order of the ownership in the pending state update information with the change order of the ownership in the current target state information.

Step Y102, in response to the change order of the ownership in the pending state update information being greater than the change order of the ownership in the current target state information, verifying the pending state update information as the effective state update information, and acquiring the verification success result.

Step Y103, in response to the change order of the ownership in the pending state update information being smaller than the change order of the ownership in the current target state information, verifying the pending state update information as the ineffective state update information, and acquiring the verification failure result.

FIG. 13 is a schematic diagram of an execution process of verifying pending state update information provided by other embodiments of the present disclosure.

For example, for step Y11, in some embodiments, the change order in the pending state update information in the above step Y11 is configured to be compared with the change order in the current target state information of the target item 330 to verify the pending state update information, which may further include at least one of step Y201 to step Y203 as shown in FIG. 13.

Step Y201, in response to the change order of the ownership in the pending state update information being equal to the change order of the ownership in the current target state information, comparing the change order of the authority in the pending state update information with the change order of the authority in the current target state information.

Step Y202, in response to the change order of the authority in the pending state update information being greater than the change order of the authority in the current target state information, verifying the pending state update information as the effective state update information, and acquiring the verification success result.

Step Y203, in response to the change order of the authority in the pending state update information being smaller than the change order of the authority in the current target state information, verifying the pending state update information as the ineffective state update information, and acquiring the verification failure result.

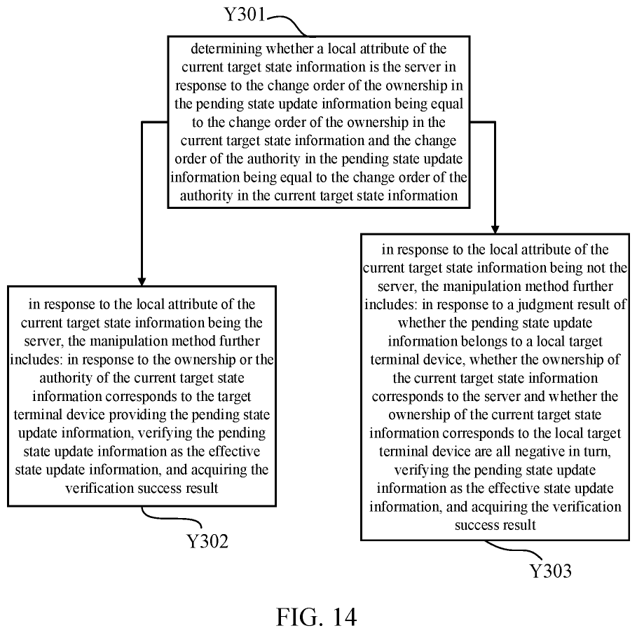

FIG. 14 is a schematic diagram of an execution process of verifying pending state update information provided by some embodiments of the present disclosure.

For example, for step Y11, in some embodiments, the change order in the pending state update information in the above step Y11 is configured to be compared with the change order in the current target state information of the target item 330 to verify the pending state update information, which may further include at least one of step Y301 to step Y303 as shown in FIG. 14.

Step Y301, determining whether a local attribute of the current target state information is the server 200 in response to the change order of the ownership in the pending state update information being equal to the change order of the ownership in the current target state information and the change order of the authority in the pending state update information being equal to the change order of the authority in the current target state information.

Step Y302, in response to the local attribute of the current target state information being the server 200, the manipulation method further includes: in response to the ownership or the authority of the current target state information corresponds to the target terminal device providing the pending state update information, verifying the pending state update information as the effective state update information, and acquiring the verification success result.

Step Y303, in response to the local attribute of the current target state information being not the server 200, the manipulation method further includes: in response to a judgment result of whether the pending state update information belongs to a local target terminal device, whether the ownership of the current target state information corresponds to the server and whether the ownership of the current target state information corresponds to the local target terminal device are all negative in turn, verifying the pending state update information as the effective state update information, and acquiring the verification success result.

The embodiment of the present disclosure, based on the fact that ownership is higher than authority, and by utilizing the change order in the state update information of the item, it is possible to realize timely, effective and accurate updating of the state information of an item under various application scenarios, which is conducive to enhancing the player's sense of experience, and the scheme is highly pervasive with a wide range of application prospects.

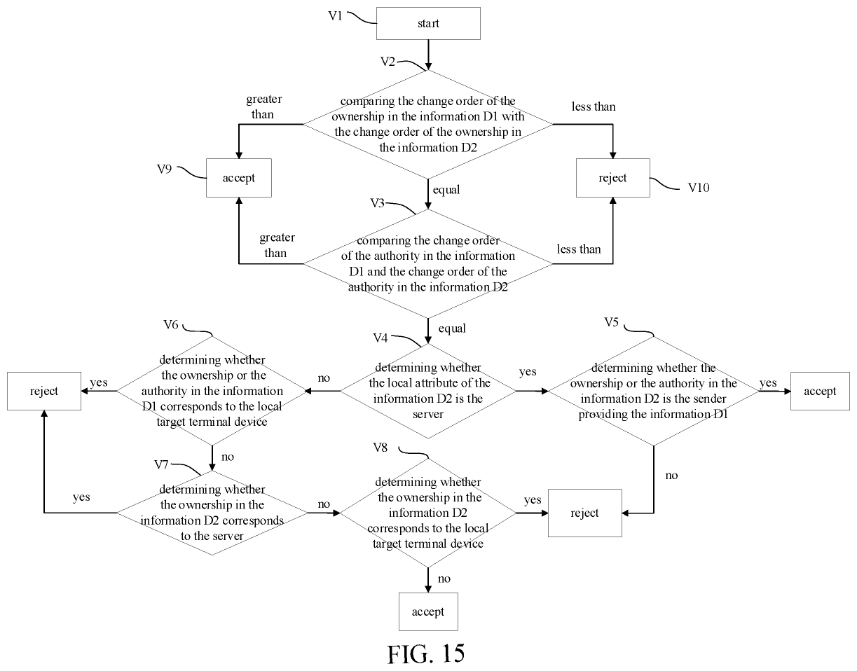

FIG. 15 is a flowchart of an execution process of step Y11 of the method in FIG. 9.

It should be noted that, for the convenience of description, the pending state update information in the example of FIG. 15 maybe referred to as information D1 and the current target state information may be referred to as information D2.

For example, in the example of FIG. 15, “accept” means that the pending state update information is verified as the effective state update information, and the verification success result is acquired, that is, the information D1 is accepted as the latest state information of this round; “reject” means that the pending state update information is verified as the ineffective state update information, and the verification failure result is acquired, that is, the information D1 is not accepted as the latest state information of this round. For example, in the example of FIG. 15, only one place of “accept” and “reject” marks the step or process, but they have the same meaning as “accept” or “reject” in other places, and they do not differ with the position in the layout of the flowchart.

For example, as shown in FIG. 15, an example of step Y11 includes at least step V1 to step V10.

Step V1, start the verification.

Step V2, comparing the change order of the ownership in the information D1 (for example, noted as a change order sq1) with the change order of the ownership in the information D2 (for example, noted as a change order sq2); if the change order sq1 is less than the change order sq2, then go to step V10; if the change order sq1 is greater than the change order sq2, then go to step V9; if the change order sq1 is equal to the change order sq2, go to step V3.

Step V3, comparing the change order of the authority in the information D1 (for example, notated as a change order sq3) and the change order of the authority in the information D2 (for example, notated as a change order sq4); if the change order sq3 is less than the change order sq4, go to step V10; if the change order sq3 is greater than the change order sq4, go to step V9; if the change order sq3 is equal to the change order sq4, go to step V4.

Step V4, determining whether the local attribute of the information D2 is the server 200: if yes, go to step V5; if not, go to step V6.

Step V5, determining whether the ownership or the authority in the information D2 is the sender providing the information D1: if yes, go to step V9; if not, go to step V10.

Step V6, determining whether the ownership or the authority in the information D1 corresponds to the local target terminal device; if yes, go to step V10; if not, go to step V7.

Step V7, determining whether the ownership in the information D2 corresponds to the server 200; if yes, go to step V10; if not, go to step V8.

Step V8, determining whether the ownership in the information D2 corresponds to the local target terminal device; if yes, go to step V10; if not, go to step V9.

Step V9, accept, i.e., the information D1 is verified as the effective state update information, and acquire the verification success result.

Step V10, reject, i.e., the information D1 is verified as the ineffective state update information, and acquire the verification failure result.

For example, in step V4, the local attribute of the information D2 is the server 200, which may represent a scenario that the latest state update information that the server 20 currently has is also the latest state update information corresponding to each of other terminal devices. For example, in step V4, the local attribute of the information D2 is not the server 200, and this may indicate a scenario in which each of other terminal devices has or has been informed of state update information that is more recent than the latest state update information on the server 200, but has not been synchronized and communicated to the server 200. This is merely exemplary and is not a limitation of the embodiments of the present disclosure.

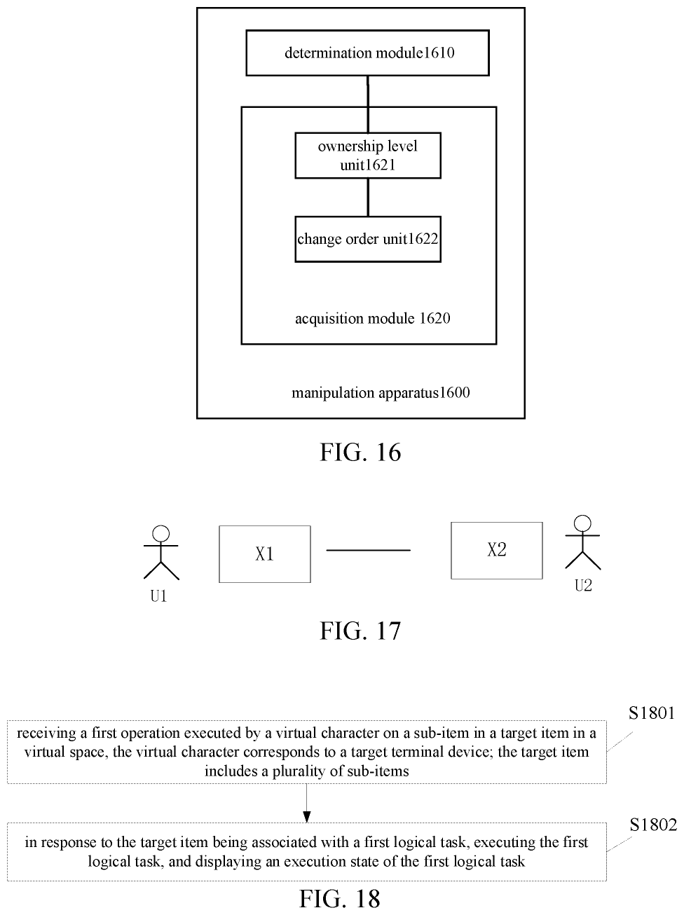

FIG. 16 is a block diagram of a manipulation apparatus for a virtual space provided by some embodiments of the present disclosure.

For example, as shown in FIG. 1, FIG. 2 and FIG. 16, a manipulation apparatus 1600 for virtual space provided by at least one embodiment of the present disclosure includes a determination module 1610 and an acquisition module 1620. The virtual space 300 is created based on the server 200 and at least one target terminal device 100 communicatively connected with the server 200. The virtual space 300 is provided with at least one first virtual image and at least one second object manipulated by the first virtual image. The determination module 1610 is configured to determine the virtual character corresponding to the target terminal device 100 in the virtual space from the at least one first virtual image. The acquisition module 1620 is configured to acquire, in response to the control operation on the target item 330 in at least one second object in the virtual space 300, the state update information of the target item 330 based on the control operation, in which the state update information includes the ownership level of the target item 330, the ownership level of the target item 330 includes the ownership corresponding to the virtual character and/or the authority corresponding to the virtual space, and the authority of the virtual space 300 includes the authority corresponding to the virtual character or the authority corresponding to the server 200.

In some embodiments, the state update information of the target item 330 may further include a change order corresponding to the ownership level of the target item 330. In some embodiments, the acquisition module 1620 further includes an ownership level unit 1621 and a change order unit 1622. The ownership level unit 1621 is configured to acquire, in response to the control operation on the target item 330 in the at least one second object in the virtual space 300, the ownership level of the target item 330 based on the control operation, and the change order unit 1622 is configured to acquire, in response to the control operation on the target item 330 in the at least one second object in the virtual space 300, the change order corresponding to the ownership level of target item 330 based on the control operation.

It should be noted that in the embodiment of the present disclosure, the manipulation apparatus for the virtual space may include more or less modules, and the connection relationship between the modules is not limited, and may be determined according to actual needs. The specific structure of each module is not limited. For the specific execution and technical effects of the manipulation apparatus for virtual space, reference can be made to the related contents of the manipulation method for the virtual space provided in the above-mentioned embodiments of the present disclosure, which will not be repeated here.

Each module in the above embodiment may be configured as software, hardware, firmware or any combination of the above items to execute specific functions. For example, these modules may correspond to dedicated integrated circuits, pure software codes, and modules combining software and hardware.

It should be noted that although the manipulation apparatus for the virtual space is divided into modules for executing corresponding processing respectively when described above, it is clear to those skilled in the art that the processing executed by each module may also be executed without any specific module division of the manipulation apparatus or clear demarcation between modules.

Some embodiments of the present disclosure provide another manipulation method for a virtual space, in example 1, the method comprises:
receiving a first operation executed by a virtual character on a sub-item in a target item in a virtual space, wherein the virtual character corresponds to a target terminal device; the target item comprises a plurality of sub-items; and
in response to the target item being associated with a first logical task, executing the first logical task, and displaying an execution state of the first logical task.

Example 2, in the method of example 1, the first logical task comprises user generated content.

Example 3, the method of example 1 further comprises:
in response to the target item not being associated with a logical task, executing the first operation on the sub-item.

Example 4, the method of example 1 further comprises:
receiving operation information of the first operation performed by each of at least two virtual characters on the sub-item of the target item in the virtual space; wherein the target item is associated with the first logical task; wherein target terminal devices corresponding to the at least two virtual characters respectively execute the first logical task locally according to the first operation and display the execution state of the first logical task;
determining an owner from the at least two virtual characters, and acquiring a target execution state of the first logical task in a first target terminal device corresponding to the owner; controlling other target terminal devices in the target terminal devices except the first target device to update locally displayed execution state of the first logical task according to the target execution state.

Example 5, in the method of example 4, the determining the owner from the at least two virtual characters, comprises:
determining the owner from the at least two virtual characters according to an ownership level of the target item, wherein the ownership level of the target item comprises an ownership corresponding to the virtual character and/or an authority corresponding to the virtual character.

Example 6, in the method of example 5, the determining the owner from the at least two virtual characters according to the ownership level of the target item, comprises:
in response to the at least two virtual characters corresponding to a same ownership level, determining the owner from the at least two virtual characters according to time information that the target item obtains the same ownership level of each of the at least two virtual characters.

Example 7, the method of example 5 further comprises:
in response to the first operation executed by the virtual character realizing grasping of the target item, making the target item have the ownership corresponding to the virtual character; or,
in response to the first operation executed by the virtual character realizing touching the target item, making the target item have the authority corresponding to the virtual character.

Example 8, in the method of example 5, the determining the owner from the at least two virtual characters according to the ownership level of the target item, comprises:
determining the owner from the at least two virtual characters according to an ownership priority of the target item,
wherein an ownership priority of the ownership of the target item corresponding to the virtual character is greater than an ownership priority of the authority of the target item corresponding to the virtual character.

Example 9, in the method of example 5, the target item comprises a first sub-item and a second sub-item, and the first logical task is associated with the second sub-item; the determining the owner from the at least two virtual characters, comprises:
in response to a first ownership level of the first sub-item corresponding to a first character being different from a second ownership level of the second sub-item corresponding to a second character, determining a character corresponding to an ownership level with a higher priority among the first ownership level and the second ownership level as the owner; or,
in response to the first ownership level and the second ownership level being the same, determining the second character as the owner.

Some embodiments of the present disclosure provide another manipulation apparatus for a virtual space, comprising:
a first receiving unit, is configured to receive a first operation executed by a virtual character on a sub-item in a target item in a virtual space, wherein the virtual character corresponds to a target terminal device; the target item comprises a plurality of sub-items; and
a first executing unit, is configured to execute the first logical task, and display an execution state of the first logical task in response to the target item being associated with a first logical task.

Some embodiments of the present disclosure provide another electronic device, comprising: a processor and a memory; the memory stores computer execution instructions; the computer execution instructions, when executed by the processor, causing the processor to implement the method according to any one of examples 1 to 9.

Some embodiments of the present disclosure provide another computer readable storage medium, wherein computer execution instructions are stored in the computer readable storage medium, and the computer execution instructions, when executed by a processor, implements the method according to any one of examples 1 to 9 is realized.

Extended Reality (XR) refers to a combination of reality and virtual through computers to create a virtual environment that allows for human-computer interaction. Extended reality technology uses computers to generate three-dimensional dynamic virtual scenes, which may comprise three-dimensional virtual items.

Users may use corresponding extended reality devices to enter the extended reality scene through the network, and interact with the objects in the extended reality scene.

Multiple users may use clients (such as clients running in mobile terminals, desktop or portable computers) to participate in extended reality scenes (such as game scenes) through the network. In the extended reality scene, users may interact with objects in the extended reality. For example, moving items in the extended reality, communicating with other characters in the extended reality, etc.

In order to make the scenes presented by corresponding clients of the multiple users consistent, multi-client synchronization is needed. Frame synchronization and/or state synchronization are considered for multi-client synchronization.

For the frame synchronization, the client uploads a current operation instruction to a server according to a certain frame rate of logical frame, and the server broadcasts the operation instruction to all the clients. When the client receives the operation instruction broadcast by the server, the client executes the code corresponding to the operation instruction locally. If input operation instructions are consistent and calculation processes are consistent, then calculation results are consistent, thus ensuring the synchronization of all the clients.

The state synchronization refers to synchronizing status of the clients to ensure that the status after each operation is consistent. In the process of state synchronization, the client uploads an operation to the server, and after receiving the operation, the server calculates results caused by an operation behavior in the scene according to the operation, and then distributes various states in the structure to the clients by broadcasting, and then displays the scene content according to the states after receiving the states. The client needs to collect the user's operation and send it to the server through the network, the server obtain a corresponding logical output result according to the operation, and then the server broadcasts the information corresponding to the logical output result to other clients, therefore, the state synchronization process includes network time consuming for data flow round-trip, as well as time consuming for computation performed by the server in response to the operation, resulting in high latency.

In addition, virtual object in the extended reality may include multiple sub-items. In the case where the virtual object includes the multiple sub-items, when to execute the logical task used to implement operation on virtual object is a problem that needs to be solved.

Please refer to FIG. 17, which shows a schematic diagram of an application scenario of the present disclosure. As shown in FIG. 17, multiple users U1 and U2 use their respective terminal devices (e.g., extended reality devices) X1 and X2 to participate in extended reality scenario (e.g., a virtual reality game scene) via the network. The extended reality devices X1 and X2 correspond to their respective first virtual image. At least one virtual object is included in the extended reality scene. The first virtual image may include a virtual character (player character). Each virtual character may correspond to a terminal device. In addition, the first virtual image may further include a non-player character. For example, when the user U1 executes an operation on the virtual object in the extended reality scene through an input apparatus, it is necessary to show consistent logical operation results in the extended reality devices X1 and X2 of the users U1 and U2, that is, it is necessary to synchronize multiple people in the extended reality scene. In the extended reality scene, the real-time response of user operation is more demanding.

Because the experience of delay is very obvious in the extended reality scene, neither the frame synchronization nor the state synchronization can meet the requirements of delay in the extended reality scene. How to ensure the consistency of all clients while also reducing the experience caused by delay is a technical problem that needs to be solved in extended reality.

In order to solve the problem above, in the scheme provided by the present disclosure, directly executes the logical task associated with the target item when receiving a first operation on the sub-item of the target item in virtual space, so that the terminal device receiving the first operation may execute the logical task according to the received first operation without delay.

Please refer to FIG. 18, FIG. 18 is a first flowchart of a manipulation method for a virtual space provided by an embodiment of the present disclosure. As shown in FIG. 18, the method includes:

S1801, receiving a first operation executed by a virtual character on a sub-item in a target item in a virtual space, in which the virtual character corresponds to a target terminal device; the target item includes a plurality of sub-items.

An execution subject of the manipulation method for the virtual space in the present disclosure may be the extended reality device, specifically the client running in the extended reality device, and the client may be a client used by the user to participate in the virtual space. The execution subject may also be a server that provides services for the clients. The client and the server may also be combined as the execution subject.

In the extended reality scene, multiple users may participate in the extended reality scene through their respective corresponding clients.

The extended reality device may be a wearable extended reality device, such as a head-mounted extended reality device.

In the extended reality scene, multiple virtual objects may be displayed by a computer technology. The virtual object may include virtual character, virtual item, etc.

The target item belongs to the virtual object.

The target item may include a plurality of sub-items. For example, a rocket body and an igniter in the extended reality scene may be two sub-items of the target item of the rocket.

The target item may be associated with the logical task in advance.

The logical tasks may include one or more of moving, changing pose, adjusting color, changing size, copying, logical operation, logical control, etc.

The users may interact with the extended reality scene by using various interactive apparatuses. For example, interactive information with the extended reality scene may be input through a movement of a handle, pressing operation executed by the up, down, left and right moving keys set on the handle, and a movement of the wearable extended reality device.

The user may realize the first operation on the sub-item of the target item through the interactive apparatus.

The first operation includes: moving, touching, grasping and throwing, etc.

As an implementation, the sub-item of the target item may include a sub-item with a grasping point. In this implementation, the target item may have only one grasping point. When the user triggers the execution of the sub-item corresponding to the grasping point by using the interactive apparatus, the first operation may be a grasping operation.

When the user executes an operation on other positions of the sub-item except the grasping point, the first operation may be a touch operation. When the user touches the sub-item with the grasping point through the interactive apparatus and moves the handle or moves the headset while maintaining the touch, the first operation may be a moving operation. When the user executes the grasping operation on the sub-item with the grasping point and executes a parabolic motion through the interactive apparatus, the first operation may be a throwing operation on the target item.

S1802, in response to the target item being associated with a first logical task, executing the first logical task, and displaying an execution state of the first logical task.

The target item may be associated with the first logical task in advance.

The first logical task may be to establish an association relationship with the whole target item or one or more sub-items of the target item.

The first logical task above may include a logical condition and/or one or more associated operations.

The first logical task above may include one or more of moving, changing pose, adjusting color, changing size, copying, logical operation, special effect display, logical control, etc.

In this embodiment, each client participating in the extended reality scene may store execution logic corresponding to a plurality of logical tasks.

After receiving the first operation on the sub-item of the target item in step S1801, the execution subject, that is, the client, may determine the execution logic corresponding to the first logical task. And then the execution subject may execute the first logical task according to the execution logic.

In this embodiment, receiving the first operation executed by a virtual character on a sub-item in a target item in a virtual space, in which the virtual character corresponds to a target terminal device and the target item includes the plurality of sub-items; and in response to the target item being associated with a first logical task, executing the first logical task, and displaying the execution state of the first logical task, thereby realizing the execution of the first logical task associated with the target item in the extended reality scenario through the operation performed on the sub-items of the target item, which allows the execution of the first logical task without delay, and in addition, provides convenience for the user to manipulate the target object.

In some embodiments, the first logical task includes user generated content.

User Generated Content (UGC) may be supported in the extended reality scene, that is, the users may display their original content or provide their original content to other users through the Internet in the extended reality scene. In the process of a UGC logic creation, it is impossible to constrain data structure type used by the users. When the data structure type used by user include data type (such as floating-point data type) that will get different calculation result when it is processed by different processing devices, it is impossible to ensure that the same operation result is obtained in each client by using the frame synchronization. This is because in the frame synchronization, different clients compute based on the same input through a consistent engine and logic, resulting in the same output across clients. The frame synchronization is extremely demanding in terms of consistency of engine and logical calculation, otherwise it will lead to unsynchronized performance among clients due to the continuous accumulation of inconsistent errors. Therefore, when users of different clients execute trigger operation on the virtual item associated with the UGC logic through the frame synchronization, the consistency of operation execution results may not be guaranteed at different clients.

In the present disclosure, the UGC logic creation may be a combination creation of pre-provided capabilities to acquire a logical task block. The logical task block may correspond to a custom logical task. The pre-provided capabilities include logic operation, logic control, events, movement, appearance, characteristics, replication, and so on. The logical task block includes a combination of logical capabilities selected by the user to be stitched together in a reasonable order to complete one or more tasks. The logic block may also be associated with the virtual item in the UGC logic creation. The virtual item may be a virtual item associated with the logical task.

The logical operations include addition, subtraction, multiplication and division, etc. Schematically, for different object sets A and B in the virtual scene, if one object in the object set A is transferred to the object set B, the amount of object in the object set A is reduced by 1, and the amount of object in the object set B is increased by 1.

The logic control may include a logic control realized by control statements such as if and else.

The events may trigger an operation or realize the interaction between different items.

The appearance above includes color, size, etc.

By manipulating the target item of the first logical task including the user generated content utilizing the manner of the embodiment shown in FIG. 2, after receiving the first operation, the first logical task corresponding to the target item is executed, and the first logical task including the user generated content can be executed without delay.

In some embodiment, that method further includes: in response to the target item not being associated with the logical task, executing the first operation on the sub-item.

In the embodiments of the present disclosure, in the case where the target item is not associated with the logical task, the manipulation of the sub-item may be completed according to the received first operation, such as position movement and attitude change. Schematically, in the case where the target item is not associated with the logical task, the first operation is a moving operation of the virtual character to the sub-item, and position movement of the sub-item according to the first operation may be displayed in the extended reality.

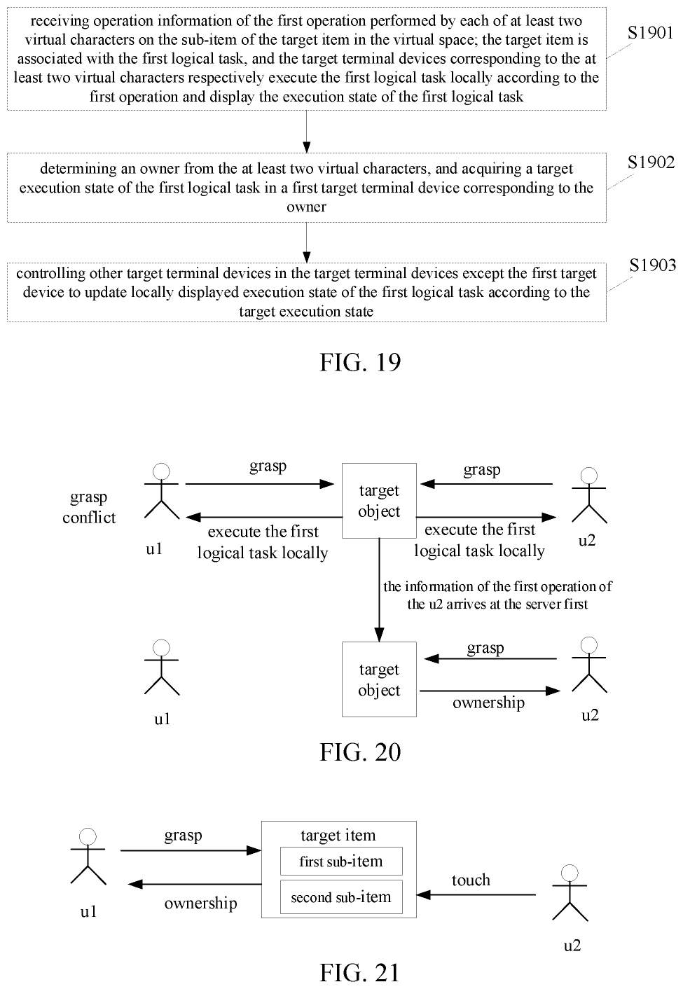

Please refer to FIG. 19, FIG. 19 is a second flowchart of a manipulation method for a virtual space provided by an embodiment of the present disclosure. As shown in FIG. 19, the method includes:

S1901, receiving operation information of the first operation performed by each of at least two virtual characters on the sub-item of the target item in the virtual space; in which the target item is associated with the first logical task, and the target terminal devices corresponding to the at least two virtual characters respectively execute the first logical task locally according to the first operation and display the execution state of the first logical task.

In this embodiment, the execution subject of the manipulation method for the virtual space may be the extended reality device or the server providing services for the extended reality device. In addition, the extended reality device and the server may be combined as the execution subject.

Each virtual character may correspond to an extended reality device.

The first logical task may be to establish an association relationship with the whole of the target item or one or more sub-items of the target item.

The first logical task may include a logical condition and/or one or more associated operations.

In this embodiment, the target item may include a plurality of sub-items. The target item may be associated with the first logical task in advance. The first logical task may be the user generated content.

At least two virtual characters may respectively execute the first operation on the sub-items of the target item. Because at least two virtual characters respectively executed the first operation on the sub-item, an issue of an operation competition arises. In order to reduce the delay caused by the operation competition so that users may browse an effect of the first operation in time, the terminal device corresponding to each virtual character may execute the first logical task at the local terminal after the first operation of the corresponding virtual character is completed, and may display the execution state of the first logical task at the local terminal.

S1902, determining an owner from the at least two virtual characters, and acquiring a target execution state of the first logical task in a first target terminal device corresponding to the owner.

According to various methods, the owner may be determined from the at least two virtual characters, and the terminal device corresponding to the owner is taken as the target terminal device, and the execution state of the first logical task in the target terminal device is taken as the target execution state of the first logical task.

The owner may be determined from the plurality of virtual characters according to the information of the first operation corresponding to each of the plurality of virtual characters. For example, the owner is determined according to time information, operation type information, and the like in the first operation information. In some application scenarios, the virtual character corresponding to the first operation with the previous time is the owner. In other application scenarios, the owner may be determined according to the operation type of the first operation corresponding to each of the virtual characters, for example, compared with the first operation of the contact (touch) type, the virtual character of the first operation of the grip type may be the owner. For another example, compared with the first operation of indirect contact, the virtual character corresponding to the first operation of direct contact is the owner.

After determining the owner, the server may acquire the execution state of the first logical task corresponding to the owner and synchronize the execution state to the terminal devices of other virtual characters.

In some embodiments, the determining an owner from the at least two virtual characters, includes:
determining the owner from the at least two virtual characters according to an ownership level of the target item, in which the ownership level of the target item includes an ownership corresponding to the virtual character and/or an authority corresponding to the virtual character.

The ownership level of the target item corresponding to different virtual characters may be different. The ownership level of the target item corresponding to different virtual characters may be preset, or may be determined according to the first operation executed by the virtual characters on the sub-items of the target item.

As an implementation mode, the method further includes:
in response to a first operation executed by the virtual character realizing grasping of the target item, making the target item have the ownership corresponding to the virtual character; or, in response to the first operation executed by the virtual character realizing touching the target item, making the target item have the authority corresponding to the virtual character.

In this implementation, the ownership level of the target item corresponding to each virtual character is determined by whether the first operation performed by the virtual character realizes the grasping or the touching of the target object. It is beneficial to determine the owner from different virtual characters according to the corresponding first operations.

In some embodiments, the determining the owner from the at least two virtual characters according to the ownership level of the target item, includes:
determining the owner from the at least two virtual characters according to an ownership priority of the target item, in which an ownership priority of the ownership of the target item corresponding to the virtual character is greater than an ownership priority of the authority of the target item corresponding to the virtual character.

In these embodiments, the ownership priority of the ownership of the target item corresponding to the virtual character is greater than the ownership priority of the authority of the target item corresponding to the virtual character. That is, if the first operation executed by a virtual character A on the sub-item of the target item realizes the grasping of the target item, and the first operation executed by a virtual character B on the sub-item of the target item realizes the touch of the target item, so the ownership priority of the target item corresponding to the virtual character A is greater than the ownership priority of the target item corresponding to the virtual character B.

The virtual character with the highest ownership priority may be used as the target virtual character. The terminal device corresponding to the target virtual character is taken as the first target terminal device.

After determining the first target terminal device, the execution state of the first logical task in the first target terminal device may be acquired.

S1903, controlling other target terminal devices in the target terminal devices except the first target device to update locally displayed execution state of the first logical task according to the target execution state.

For example, the execution state of the first logical task in the first target terminal device may be sent to other terminal devices for display to replace the execution state of the first logical task in other terminal devices.

In this embodiment, the plurality of virtual characters in the extended reality scene respectively execute the first operation on the target item, that is, the plurality of terminal devices respectively receives the first operation on the target item. Therefore, multiple first operations on the target item are in conflict.

In order to solve the problem of response delay caused by the conflict, after receiving the first operation on the first virtual object, each terminal device may execute the first logical task associated with the target item locally. furthermore, the terminal device may also determine the owner from the plurality of virtual characters. After determining the owner, each terminal device may be controlled to finally display the execution state of the first logical task corresponding to the owner. On one hand, it realizes the client's response to a local operation without delay; On the other hand, for the logical task with an execution conflict, the logical task execution state corresponding to the client with permission to execute the logical task is used to override the logical task execution state in other clients, thus realizing the consistency of the logical task execution results displayed by each client.

Please refer to FIG. 20, which shows a schematic diagram of an application scenario. As shown in FIG. 20, a virtual character u1 and a virtual character u2 respectively execute the first operation on the sub-item of the target item. The first operation realizes the grasping operation of the target item, that is, the ownership level of the target item corresponding to the virtual character u1 and the ownership level of the target item corresponding to the virtual character u2 are both the ownership, and have the same ownership level, and there is a conflict at this time. The terminal device of the virtual character u1 and the terminal device of the virtual character u2 respectively execute the first logical task locally. The information of the first operation of the virtual character u2 arrives at the server first, and the terminal device of the virtual character u2 may be determined as the first target terminal device, and the virtual character u2 is the character that has the ownership of the grasping operation on the target item. The terminal device of the virtual character u2 may send a local execution state of the first logical task to the server. The server sends the above execution state to the terminal device of the virtual character u1. The terminal device of the virtual character u1 replaces local execution state of the first logical task with the above execution state. So as to determine the owner from the virtual character in case of conflict of the first operation, and display the execution state of the first logical task corresponding to the owner in other terminal devices, thereby realizing consistency in the execution result of the first logical task displayed on each terminal device.

In some embodiments, the target item includes a first sub-item and a second sub-item, and the first logical task is associated with the second sub-item; the determining the owner from the at least two virtual characters, includes:
in response to a first ownership level of the first sub-item corresponding to a first character being different from a second ownership level of the second sub-item corresponding to a second character, determining a character corresponding to the ownership level with a higher priority among the first ownership level and the second ownership level as the owner; or, in response to the first ownership level and the second ownership level being the same, determining the second character as the owner.

Please refer to FIG. 21, which shows another application scenario schematic diagram. As shown in FIG. 21, the virtual character u1 executes a grasping operation on the first sub-item in the target item (a sub-item with a grasping point in the target item), and the virtual character u2 executes a touching operation on the second sub-item of the target item. The second sub-item is associated with the first logical task. The terminal device of the virtual character u1 and the terminal device of the virtual character u2 respectively execute the first logical task locally. The terminal device of the virtual character u1 may send information of the grasping operation to the server, and the terminal device of the virtual character u2 may send information of the touching operation executed on the second sub-item to the server. The server may determine the owner according to the ownership priority corresponding to the target characters of different operation types.

The priority of the grasping (corresponding to the ownership) is higher than the priority of the touching (corresponding to the authority), so the virtual character u1 may be determined as the owner, that is, the virtual character u1 has the ownership to operate the target item. The terminal device of the virtual character u1 is the first target terminal device. The first target terminal device of the virtual character u1 may synchronize the local execution state of the first logical task to other terminal devices for display, and cause the other terminal devices to replace the local execution state of the first logical task.

In the case where the first sub-item is not provided with the grip point, the virtual character u1 executes the touch operation on the first sub-item of the target item, while the virtual character u2 executes the touch operation on the second sub-item of the target item. The second sub-item is associated with the first logical task. The virtual characters u1 and u2 all execute the touch operation (both corresponding to the authority), that is, the first ownership level of the first sub-item corresponding to the first character and the second ownership level of the second sub-item corresponding to the second character are the same. Because the second sub-item is associated with the first logical task, the virtual character u2 is regarded as the owner. Synchronize the execution state of the first logical task in the terminal device of the virtual character u2 to the terminal device of the virtual character u1.

Based on the above, it is realized that the owner is determined from a plurality of virtual characters in the case of a conflict of the first operation, and the execution state of the first logical task of the terminal device corresponding to the owner is synchronously displayed in other terminal devices, and the display consistency of the terminal devices corresponding to each of the virtual characters can be realized.

As a scene, for example, the target item is a rocket, which includes a rocket body and an igniter. The rocket body and the igniter are sub-items of the rocket respectively. The rocket body is associated with the first logical task and trigger condition of the logical task. The first logical task consists of an ignition event and a rocket launch event. The trigger condition include the touching of the rocket body by the igniter.

In one example, a virtual character B1 executes a move operation on the igniter, but does not cause the igniter to touch the rocket body, so that it is a displacement operation executed on the igniter. The operation on the igniter may be displayed in the terminal device of the virtual character in real time. And the displacement operation executed on the igniter will not be synchronized to the electronic devices corresponding to other virtual characters. In one example, a virtual character B2 executes the move operation on the igniter and cause the igniter to touch the rocket body, that is, the first operation is executed on the rocket. As a result of touching the igniter to the rocket, the ownership level of the rocket includes the authority of the virtual character B2. Therefore, the terminal device of the virtual character B2 will execute the first logical task associated with the rocket, that is, launching the rocket.

In one example, the virtual character B1 and the virtual character B2 both execute the move operation on the igniter and cause the igniter to touch the rocket body, that is, the virtual character B1 and the virtual character B2 both execute the first operation on the rocket. If the information of the first operation executed by the virtual character B1 on the rocket reaches the server first, the virtual character B1 serves as the owner, and the terminal device corresponding to the virtual character B1 is the first target terminal device. The launching state of the rocket on the first target terminal device is taken as the target execution state of the first logical task and synchronized to the terminal device of the virtual character B2.

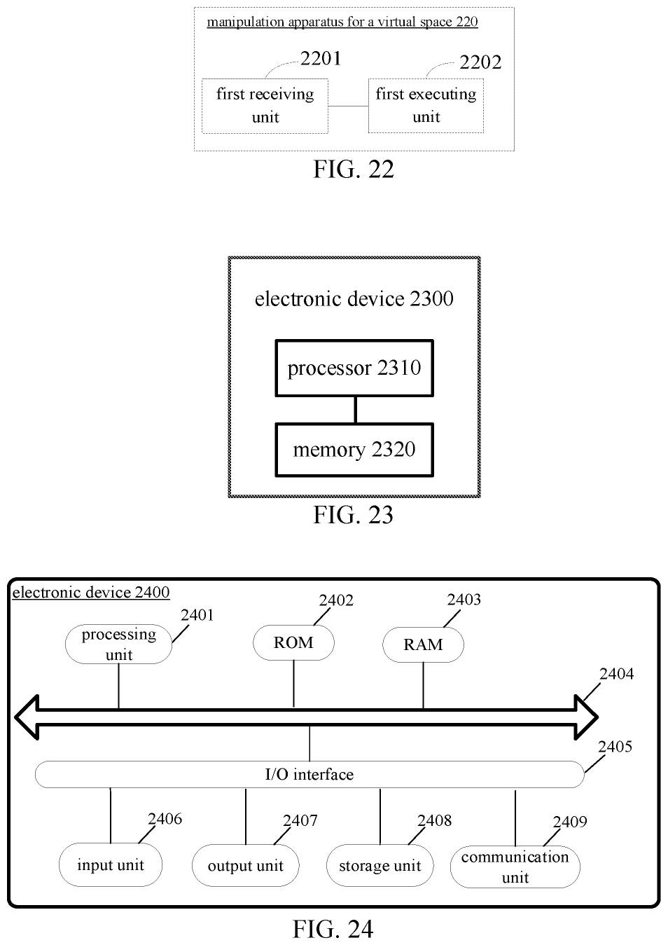

Corresponding to the manipulation method for the virtual space in the embodiment shown in FIG. 18 above, FIG. 22 is a structural block diagram of a manipulation apparatus for a virtual space provided by the embodiment of the present disclosure. For convenience of explanation, only parts related to the embodiment of the present disclosure are shown. Referring to FIG. 22, the apparatus 220 includes a first receiving unit 2201 and a first executing unit 2202. Among them:
the first receiving unit 2201 is configured to receive a first operation executed by a virtual character on a sub-item in a target item in a virtual space, in which the virtual character corresponds to a target terminal device; the target item includes a plurality of sub-items;
the first executing unit 2202 is configured to execute the first logical task and display the execution state of the first logical task in response to the target item being associated with a first logical task.

In some embodiments of the present disclosure, the first logical task includes user generated content.

In some embodiments of the present disclosure, the first executing unit 2202 is further configured to:
in response to the target item not being associated with a logical task, execute the first operation on the sub-item.

In some embodiments of the present disclosure, the apparatus 220 further includes a second executing unit (not shown in the figure), the second executing unit is configured to:
receive operation information of the first operation performed by each of at least two virtual characters on the sub-item of the target item in the virtual space; in which the target item is associated with the first logical task; in which the target terminal devices corresponding to the at least two virtual characters respectively execute the first logical task locally according to the first operation and display the execution state of the first logical task;
determine an owner from the at least two virtual characters, and acquire a target execution state of the first logical task in a first target terminal device corresponding to the owner; control other target terminal devices in the target terminal devices except the first target device to update locally displayed execution state of the first logical task according to the target execution state.

In some embodiments of the present disclosure, the second executing unit is further configured to:
determine the owner from the at least two virtual characters according to an ownership level of the target item, in which the ownership level of the target item includes an ownership corresponding to the virtual character and/or an authority corresponding to the virtual character.

In some embodiments of the present disclosure, the second executing unit is further configured to determine the owner from the at least two virtual characters according to time information that the target item obtains the same ownership level of each of the at least two virtual characters in response to the at least two virtual characters corresponding to a same ownership level.

In some embodiments of the present disclosure, the apparatus further includes an ownership level determining unit, which is configured to:
in response to the first operation executed by the virtual character realizing grasping of the target item, making the target item have the ownership corresponding to the virtual character; or,
in response to the first operation executed by the virtual character realizing touching the target item, making the target item have the authority corresponding to the virtual character.

In some embodiments of the present disclosure, the second executing unit is further configured to:
determine the owner from the at least two virtual characters according to an ownership priority of the target item, in which an ownership priority of the ownership of the target item corresponding to the virtual character is greater than an ownership priority of the authority of the target item corresponding to the virtual character.

In some embodiments of the present disclosure, the target item includes a first sub-item and a second sub-item, and the first logical task is associated with the second sub-item; The second executing unit is further configured to:
in response to a first ownership level of the first sub-item corresponding to a first character being different from a second ownership level of the second sub-item corresponding to a second character, determine a character corresponding to the ownership level with a higher priority among the first ownership level and the second ownership level as the owner; or, in response to the first ownership level and the second ownership level being the same, determine the second character as the owner.

FIG. 23 is a schematic structural diagram of an electronic device provided by at least one embodiment of the present disclosure. The electronic device 2300 includes a processor 2310 and a memory 2320, in which the memory 2320 stores a computer program, and the computer program, when executed by the processor 2310, implements the manipulation method of at least some embodiments of the present disclosure.

Electronic device in the embodiments of the present disclosure may include, but are not limited to, mobile terminals such as notebook computers, tablet computers, and fixed terminals such as desktop computers, conventional servers, and cloud servers. The electronic device shown in FIG. 23 is only an example, and should not bring any limitation to the function and application scope of the embodiment of the present disclosure.

For example, according to the embodiment of the present disclosure, the process described above with reference to the flowchart may be executed as a computer software program. For example, the embodiment of the present disclosure provides a computer program product including a computer program carried on a non-transitory computer-readable medium, which contains program code for executing the method shown in the flowchart. When the computer program is executed by the processor, the manipulation method of the embodiment of the present disclosure is executed.

It should be noted that the computer readable medium mentioned above in the present disclosure may be a computer readable signal medium or a computer readable storage medium or any combination of the two. The computer readable storage medium may be, for example, but not limited to, electrical, magnetic, optical, electromagnetic, infrared, or semiconductor system, device or device, or any combination of the above. More specific examples of computer readable storage media may include, but are not limited to, an electrical connection with one or more wires, a portable computer disk, a hard disk, a random access memory (RAM), a read-only memory (ROM), an erasable programmable read-only memory (EPROM) or flash memory, an optical fiber, a portable compact disk read-only memory (CD-ROM), an optical storage device, a magnetic storage device, or any suitable combination of the above. In the embodiment of the present disclosure, the computer readable storage medium may be any tangible medium containing or storing a program, which may be used by or in combination with an instruction execution system, apparatus or device. In the embodiment of the present disclosure, the computer readable signal medium may include a data signal propagated in baseband or as a part of a carrier wave, in which computer-readable program codes are carried. This propagated data signal may take many forms, including but not limited to electromagnetic signals, optical signals or any suitable combination of the above. The computer readable signal medium may also be any computer readable medium other than the computer readable storage medium, which may send, propagate or transmit a program for use by or in connection with an instruction execution system, apparatus or device. The program code contained in the computer readable medium may be transmitted by any suitable medium, including but not limited to: wires, optical cables, RF (radio frequency) and the like, or any suitable combination of the above.

The computer readable medium may be included in the electronic device; or it may exist alone without being assembled into the electronic device.

It should be noted that, in the embodiment of the present disclosure, the specific functions and technical effects of the electronic device 2300 mayrefer to the above description of the manipulation method, and will not be described here.

In order to realize the above embodiment, the embodiment of the present disclosure also provides an electronic device.

Referring to FIG. 24, it shows a structural schematic diagram of an electronic device 2400 suitable for implementing the embodiment of the present disclosure, which may be various terminal devices and servers. The terminal device may include the extended reality device. For example, the extended reality device may include various wearable devices, such as head-mounted extended reality devices and the like. The electronic device shown in FIG. 24 is only an example, and should not bring any limitation to the function and application scope of the embodiment of the present disclosure.

As shown in FIG. 24, the electronic device 2400 mayinclude a processing device (such as a central processor, a graphics processor, etc.) 2401, which may execute various appropriate actions and processes according to a program stored in a read only memory (ROM) 2402 or a program loaded from a storage device 2408 into a random access memory (RAM) 2403. In the RAM 2403, various programs and data required for the operation of the electronic device 2400 are also stored. The processing device 2401, the ROM 2402 and the RAM 2403 are connected to each other through a bus 2404. An input/output (I/O) interface 2405 is also connected to the bus 2404.

Generally, the following units may be connected to the I/O interface 2405: an input unit 2406 including, for example, a touch screen, a touch pad, a keyboard, a mouse, a camera, a microphone, an accelerometer, a gyroscope, and the like; an output unit 2407 including, for example, a Liquid Crystal Display (LCD), a speaker, a vibrator, and the like; a storage unit 2408 including, for example, a magnetic tape, a hard disk, and the like; a communication unit 2409. The communication unit 2409 mayallow the electronic device 2400 to execute wireless or wired communication with other devices to exchange data. Although FIG. 24 shows the electronic device 2400 with various units, it should be understood that it is not required to implement or have all the units shown. More or less units may alternatively be implemented or provided.

In particular, according to an embodiment of the present disclosure, the process described with reference to the flowchart may be implemented as a computer software program. For example, the embodiment of the present disclosure provides a computer program product, which includes computer programs hosted on a computer readable medium, and the computer program contains program codes for executing the method shown in the flowchart. In such an embodiment, the computer program may be downloaded and installed from the network through the communication unit 2409, or installed from the storage unit 2408, or installed from the ROM 2402. The functions defined in the method provided by the embodiment of the present disclosure are executed when the computer programs are executed by the processing unit 2401.

The computer readable medium carries one or more programs, which, when executed by the electronic device, cause the electronic device to execute the method shown in the embodiments.

Computer program codes for executing the operations of the present disclosure may be written in one or more programming languages or combinations thereof. The above programming languages include but not limited to object-oriented programming languages such as Java, Smalltalk, C++, and conventional procedural programming languages such as “C” language or similar programming languages. The program codes may be completely executed on the user's computer, partially executed on the user's computer, executed as an independent software package, partially executed on the user's computer and partially executed on a remote computer, or completely executed on a remote computer or server. In the case where the remote computer is involved, the remote computer may be connected to the user computer through any kind of network, such as a Local Area Network (LAN) or a Wide Area Network (WAN), or, alternatively, may be connected to an external computer (for instance, connected via the Internet by utilization of Internet service providers).

The flowcharts and block diagrams in the drawings show possible architectures, functions and operations of the system, the method and the computer program product according to various embodiments of the present disclosure. In this regard, each block in the flowchart or block diagram may represent a module, a program segment, or a part of code. The module, the program segment, or the part of the code contains one or more executable instructions for implementing specified logic functions. It should also be noted that in some alternative implementations, the functions noted in the blocks may occur in a different order than those noted in the drawings. For example, two consecutive blocks may actually be executed basically in parallel, and sometimes, may also be executed in a reverse order, determined by involved functions. It should also be noted that each block in the block diagrams and/or flowcharts, and combinations of blocks in the block diagrams and/or flowcharts may be implemented by a dedicated hardware-based system that executes specified functions or operations, or may also be implemented by a combination of a special hardware and computer instructions.

The units involved in the embodiment described in the present disclosure may be realized by software, and may also be implemented by hardware. Wherein, the name of the unit should not define the unit under certain circumstances.

The functions described above in this document may be at least partially executed by one or more hardware logical units. For instance, without limitation, demonstration type hardware logical units that may be used include: field programmable gate array (FPGA), application-specific integrated circuit (ASIC), application specific standard parts (ASSP), system on a chip (SOC), complex programmable logic device (CPLD), etc.

In the present disclosure, the machine readable medium may be a tangible medium and may include or store programs used by command execution system, device or equipment or used in combination with the command execution system, device or equipment. The machine readable medium may be a machine readable signal medium or a machine readable storage medium. The machine readable medium may include but not limited to electronic, magnetic, optical, electromagnetic, infrared, or semiconductor system, device or equipment, or any suitable combination of the above. A more specific example of the machine readable storage medium may include electrical connection based on one or more wires, portable computer disk, hard disk, Random Access Memory (RAM), Read Only Memory (ROM), Erasable Programmable Read Only Memory (EPROM), flash memory, optical fiber, Convenient Compact Disk Read Only Memory (CD-ROM), optical storage unit, magnetic storage unit, or any suitable combination of the above.

Based on one or more embodiments of the present disclosure, a manipulation method for a virtual space is provided. The virtual space is created based on a server and at least one target terminal device communicatively connected with the server, in which at least one first virtual image and at least one second object manipulated by the first virtual image are arranged in the virtual space, the manipulation method includes: determining a virtual character corresponding to the target terminal device in the virtual space from the at least one first virtual image; and in response to a control operation on a target item in the at least one second object in the virtual space, acquiring state update information of the target item based on the control operation, in which the state update information includes an ownership level of the target item, and the ownership level of the target item includes an ownership corresponding to the virtual character and/or an authority corresponding to the virtual space, and the authority of the virtual space includes the authority corresponding to the virtual character or the authority corresponding to the server.

For example, the manipulation method provided by one or more embodiments of the present disclosure further includes: controlling pose information of the target item based on the state update information of the target item to render and display the target item.

For example, in the manipulation method provided by one or more embodiments of the present disclosure, an ownership priority of the ownership of the second object corresponding to the virtual character is greater than an ownership priority of the authority of the second object corresponding to the virtual character, and the ownership priority of the authority of the second object corresponding to the virtual character is greater than an ownership priority of the authority of the second object corresponding to the server.

For example, in the manipulation method provided by one or more embodiments of the present disclosure, the ownership of the target item corresponding to the virtual character includes an identification number of the virtual character, the authority of the target item corresponding to the virtual character includes the identification number of the virtual character, and the authority of the target item corresponding to the server includes an identification number of the server.

For example, in the manipulation method provided by one or more embodiments of the present disclosure, in response to the determined virtual character including a first character corresponding to a first terminal device in the at least one target terminal device and a second character corresponding to a second terminal device in the at least one target terminal device, the in response to the control operation on the target item in the at least one second object in the virtual space, acquiring the state update information of the target item based on the control operation, including: in response to the first character and/or the second character providing a request for picking up the target item, configuring the ownership level in the acquired state update information of the target item to include the ownership level corresponding to the first character or the ownership level corresponding to the second character.

For example, in the manipulation method provided by one or more embodiments of the present disclosure, in response to the first character and/or the second character providing the request for picking up the target item, configuring the ownership level in the acquired state update information of the target item to include the ownership level corresponding to the first character or the ownership level corresponding to the second character, including: in response to the acquired ownership level of the target item including the ownership corresponding to the first character, configuring the ownership level of the target item further to include the authority corresponding to the first character; or, in response to the acquired ownership level of the target item including the ownership corresponding to the second character, configuring the ownership level of the target item further to include the authority corresponding to the second character.

The manipulation method provided by one or more embodiments of the present disclosure further includes: the first character or the second character is informed of the state update information of the target item.

For example, in the manipulation method provided by one or more embodiments of the present disclosure, the state update information of the target item further includes a change order corresponding to the ownership level of the target item, and the manipulation method further includes: determining pending state update information of the target item to be verified based on the state update information of the target item; comparing the change order in the pending state update information with the change order in current target state information of the target item to verify the pending state update information; acquiring a verification success result in response to the pending state update information being verified as the effective state update information; acquiring a verification failure result in response to the pending state update information being verified as the ineffective state update information.

For example, in the manipulation method provided by one or more embodiments of the present disclosure, in response to the target item including a first item and a second item, in response to the control operation on the target item in the at least one second object in the virtual space, acquiring the state update information of the target item based on the control operation, includes: in response to the first item contacting with the second item, acquiring the state update information of the first item and/or the state update information of the second item.

For example, in the manipulation method provided by one or more embodiments of the present disclosure, in response to the determined virtual character including a first character corresponding to a first terminal device in the at least one target terminal device and a second character corresponding to a second terminal device in the at least one target terminal device, the in response to the first item contacting with the second item, acquiring the state update information of the first item and/or the state update information of the second item, includes: in response to the first item having the ownership corresponding to the first character and the second item having the authority of the virtual space, controlling to make the first item contact with the second item, so that the ownership level of the second item is changed to include the authority corresponding to the first character, to acquire the state update information of the second item.

For example, the manipulation method provided by one or more embodiments of the present disclosure further includes: in response to the ownership level of the second item being changed to include the authority corresponding to the first character and the state update information of the second item being acquired, treating the state update information corresponding to the second item as the pending state update information to be verified to verify the pending state update information, in which the current target state information of the target item includes the current target state information of the second item; in which, in response to acquiring the verification success result, other characters corresponding to the at least one other terminal device except the first terminal device in the at least one target terminal device in the virtual space are informed that the ownership level of the second item is changed to include the authority corresponding to the first character and the pose information of the second item is synchronized with other characters; in response to acquiring the verification failure result, the current target state information is used as the updated state update information of the second item.

For example, in the manipulation method provided by one or more embodiments of the present disclosure, in response to the determined virtual character including a first character corresponding to a first terminal device in the at least one target terminal device and a second character corresponding to a second terminal device in the at least one target terminal device, the in response to the first item contacting with the second item, acquiring the state update information of the first item and/or the state update information of the second item, includes: in response to the first item losing the ownership corresponding to the first character and the first item having the authority corresponding to the first character, controlling to make the first item contact with the second item, and acquiring the ownership level of the first item and/or the ownership level of the second item to acquire the state update information of the first item and/or the state update information of the second item.

For example, in the manipulation method provided by one or more embodiments of the present disclosure, the controlling to make the first item contact with the second item, and acquiring the ownership level of the first item and/or the ownership level of the second item, including: controlling to make the first item contact with the second item, and in response to the second item having the ownership corresponding to the second character, controlling the ownership level of the first item to be changed to include the authority corresponding to the second character; controlling to make the first item contact with the second item, and in response to the second item having the authority corresponding to the server, controlling the ownership level of the second item to be changed to include the authority corresponding to the first character; controlling to make the first item contact with the second item, and in response to the authority of the second item corresponding to the second character, controlling the ownership level of the second item and the ownership level of the first item to remain unchanged.

For example, in the manipulation method provided by one or more embodiments of the present disclosure, in response to controlling the ownership level of the second item to be changed to include the authority corresponding to the first character and correspondingly acquiring the state update information of the second item, the state update information corresponding to the second item is used as the pending state update information to be verified to verify the pending state update information, in which the current target state information of the target item includes the current target state information of the second item; in which in response to acquiring the verification success result, other characters corresponding to the at least one other terminal device except the first terminal device in the at least one target terminal device in the virtual space are informed that the ownership level of the second item is changed to include the authority corresponding to the first character and the pose information of the second item is synchronized with other characters; in response to acquiring the verification failure result, the current target state information of the second item is used as the updated state update information of the second item.

For example, the manipulation method provided by one or more embodiments of the present disclosure further includes: in response to controlling the ownership level of the first item to be changed to include the authority corresponding to the second character and correspondingly acquiring the state update information corresponding to the first item, the state update information corresponding to the first item is used as the pending state update information to be verified to verify the pending state update information, in which the current target state information of the target item includes the current target state information of the first item; in which in response to acquiring the verification success result, other characters corresponding to the at least one other terminal device except the first terminal device in the at least one target terminal device in the virtual space are informed that the ownership level of the first item is changed to include the authority corresponding to the second character and the pose information of the first item is synchronized with other characters; in response to acquiring the verification failure result, the current target state information of the first item is used as the updated state update information of the first item.

For example, the manipulation method provided by one or more embodiments of the present disclosure further includes: in response to the target item not having the ownership of the virtual character and having the authority corresponding to the virtual character, controlling to keep the target item still for a preset duration, and changing the ownership level in the state update information of the target item to include the authority corresponding to the server.

For example, in the manipulation method provided by one or more embodiments of the present disclosure, comparing the change order in the pending state update information with the change order in the current target state information of the target item to verify the pending state update information, including: comparing the change order of the ownership in the pending state update information with the change order of the ownership in the current target state information; in response to the change order of the ownership in the pending state update information being greater than the change order of the ownership in the current target state information, verifying the pending state update information as the effective state update information, and acquiring the verification success result; in response to the change order of the ownership in the pending state update information being smaller than that in the current target state information, verifying the pending state update information as the ineffective state update information, and acquiring the verification failure result.

For example, the manipulation method provided by one or more embodiments of the present disclosure further includes: in response to the change order of the ownership in the pending state update information being equal to the change order of the ownership in the current target state information, comparing the change order of the authority in the pending state update information with the change order of the authority in the current target state information; in response to the change order of the authority in the pending state update information being greater than the change order of the authority in the current target state information, verifying the pending state update information as the effective state update information, and acquiring the verification success result; in response to the change order of authority in the pending state update information being smaller than that in the current target state information, verifying the pending state update information as the ineffective state update information, and acquiring the verification failure result.

For example, the manipulation method provided by one or more embodiments of the present disclosure further includes: determining whether a local attribute of the current target state information is the server, in response to the change order of the ownership in the pending state update information being equal to the change order of the ownership in the current target state information and the change order of the authority in the pending state update information being equal to the change order of the authority in the current target state information; in response to the local attribute of the current target state information is the server, further includes: in response to the ownership or the authority of the current target state information corresponds to the target terminal device providing the pending state update information, verifying the pending state update information as the effective state update information, and acquiring the verification success result; in response to the local attribute of the current target state information is not the server, further includes: in response to a judgment result of whether the pending state update information belongs to a local target terminal device, whether the ownership of the current target state information corresponds to the server and whether the ownership of the current target state information corresponds to the local target terminal device are all negative in turn, verifying the pending state update information as the effective state update information, and acquiring the verification success result.

For example, the manipulation method provided by one or more embodiments of the present disclosure further includes: acquiring the target item by acquiring an item identification number of the target item.

For example, the manipulation method provided by one or more embodiments of the present disclosure further includes: in response to the first terminal device in the target terminal device being a wearable virtual reality device and the wearable virtual reality device including a control part, synchronizing motion information of the control part of the first terminal device to the server and/or the at least one other terminal device except the first terminal device in the at least one target terminal device, in which the control part is configured to control the control operation of the virtual character corresponding to the first terminal device on the target item, and the motion information of the control part corresponds to the control input.

Based on one or more embodiments of the present disclosure, there is also provided a manipulation apparatus for a virtual space, the virtual space is created based on a server and at least one target terminal device communicatively connected with the server, in which at least one first virtual image and at least one second object manipulated by the first virtual image are arranged in the virtual space, the manipulation apparatus includes: a determination module, configured to determine a virtual character corresponding to the target terminal device in the virtual space from the at least one first virtual image; and an acquisition module, configured to respond to a control operation on a target item in the at least one second object in the virtual space, and acquire state update information of the target item based on the control operation, in which the state update information includes an ownership level of the target item, and the ownership level of the target item includes an ownership corresponding to the virtual character and/or an authority corresponding to the virtual space, and the authority of the virtual space includes the authority corresponding to the virtual character or the authority corresponding to the server.

Based on one or more embodiments of the present disclosure, an electronic device is provided, which includes a processor and a memory, in which the memory stores a computer program, and the computer program, when executed by the processor, implements any one of the above manipulation methods.

Based on one or more embodiments of the present disclosure, a computer readable storage medium is provided, in which the storage medium stores a computer program, and the computer program, when executed by a processor, implements any one of the above manipulation methods.

The above description is only the explanation of a partial embodiment of the present disclosure and the used technical principle. It should be understood by those skilled in the art that the disclosure scope involved in the disclosure is not limited to the technical solution formed by the specific combination of the above technical features, but also covers other technical solutions formed by any combination of the above technical features or their equivalent features without departing from the above disclosed concept. For example, the technical solution formed by replacing the above features with (but not limited to) technical features with similar functions disclosed in the disclosure.

In addition, although the operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in a plurality of embodiments alone or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of realizing the claims.

The following points need to be explained:
(1) The drawings of the embodiment of the present disclosure only relate to the structures involved in the embodiment of the present disclosure, and other structures may refer to the general design.
(2) In case of no conflict, the embodiment of the present disclosure and the features in the embodiment may be combined with each other to obtain a new embodiment.

The above is only the specific execution of the present disclosure, but the protection scope of the present disclosure is not limited to this, and the protection scope of the present disclosure shall be subject to the protection scope of the claims.

What is claimed is:

1. A manipulation method for a virtual space, the virtual space is created based on a server and at least one target terminal device communicatively connected with the server, at least one first virtual image and at least one second object manipulated by the first virtual image are arranged in the virtual space, the manipulation method comprises:
determining a virtual character corresponding to the target terminal device in the virtual space from the at least one first virtual image; and
in response to a control operation on a target item in the at least one second object in the virtual space, acquiring state update information of the target item based on the control operation, wherein the state update information comprises an ownership level of the target item, and the ownership level of the target item comprises an ownership corresponding to the virtual character and/or an authority corresponding to the virtual space, and the authority of the virtual space comprises an authority corresponding to the virtual character or an authority corresponding to the server.

2. The manipulation method according to claim 1, further comprising:
controlling pose information of the target item based on the state update information of the target item to render and display the target item.

3. The manipulation method according to claim 2, wherein the controlling the pose information of the target item based on the state update information of the target item to render and display the target item, comprises:
determining an owner corresponding to the ownership level based on the ownership level of the state update information of the target item, wherein the owner comprises the virtual character or the server;
acquiring a control input for the target item based on the determined owner to acquire current pose information of the target item;
rendering and displaying the target item based on the current pose information of the target item.

4. The manipulation method according to claim 3, wherein the acquiring the control input for the target item based on the determined owner to acquire the current pose information of the target item, comprises:
in response to the determined owner being the virtual character, acquiring the control input for the target item based on at least a portion of the target terminal device corresponding to the determined owner to acquire the current pose information of the target item.

5. The manipulation method according to claim 4, further comprising:
in response to the determined owner corresponding to a first terminal device among the target terminal devices, rendering and displaying the target item by the first terminal device based on the current pose information of the target item, and rendering and displaying the target item by at least one other terminal device in the at least one target terminal device except the first terminal device based on the current pose information of the target item.

6. The manipulation method according to claim 5, further comprising:
in response to the first terminal device in the target terminal device being a wearable virtual reality device and the wearable virtual reality device comprising a control part, synchronizing motion information of the control part of the first terminal device to the server and/or the at least one other terminal device in the at least one target terminal device except the first terminal device, wherein the control part is configured to control the control operation of the virtual character corresponding to the first terminal device on the target item, and the motion information of the control part corresponds to the control input.

7. The manipulation method according to claim 1, wherein an ownership priority of the ownership of the second object corresponding to the virtual character is greater than an ownership priority of the authority of the second object corresponding to the virtual character, and the ownership priority of the authority of the second object corresponding to the virtual character is greater than an ownership priority of the authority of the second object corresponding to the server.

8. The manipulation method according to claim 1, wherein the ownership of the target item corresponding to the virtual character comprises an identification number of the virtual character, the authority of the target item corresponding to the virtual character comprises the identification number of the virtual character, and the authority of the target item corresponding to the server comprises an identification number of the server.

9. The manipulation method according to claim 1, wherein in response to the determined virtual character comprising a first character corresponding to a first terminal device in the at least one target terminal device and a second character corresponding to a second terminal device in the at least one target terminal device, the in response to the control operation on the target item in the at least one second object in the virtual space, acquiring the state update information of the target item based on the control operation, comprising:
in response to the first character and/or the second character providing a request for picking up the target item, configuring the ownership level in the acquired state update information of the target item to comprise an ownership level corresponding to the first character or an ownership level corresponding to the second character.

10. The manipulation method according to claim 9, wherein the in response to the first character and/or the second character providing the request for picking up the target item, configuring the ownership level in the acquired state update information of the target item to comprise the ownership level corresponding to the first character or the ownership level corresponding to the second character, comprising:
in response to the acquired ownership level of the target item comprising an ownership corresponding to the first character, configuring the ownership level of the target item further to comprise an authority corresponding to the first character; or,
in response to the acquired ownership level of the target item comprising an ownership corresponding to the second character, configuring the ownership level of the target item further to comprise an authority corresponding to the second character.

11. The manipulation method according to claim 10, further comprising:
the first character or the second character is informed of the state update information of the target item.

12. The manipulation method according to claim 1, wherein the state update information of the target item further comprises a change order corresponding to the ownership level of the target item, and the manipulation method further comprises:
determining pending state update information of the target item to be verified based on the state update information of the target item;
comparing a change order in the pending state update information with a change order in current target state information of the target item to verify the pending state update information;
acquiring a verification success result in response to the pending state update information being verified as effective state update information;
acquiring a verification failure result in response to the pending state update information being verified as ineffective state update information.

13. The manipulation method according to claim 12, wherein in response to the target item comprising a first item and a second item, the in response to the control operation on the target item in the at least one second object in the virtual space, acquiring the state update information of the target item based on the control operation, comprises:
in response to the first item contacting with the second item, acquiring state update information of the first item and/or state update information of the second item.

14. The manipulation method according to claim 13, wherein in response to the determined virtual character comprising a first character corresponding to a first terminal device in the at least one target terminal device and a second character corresponding to a second terminal device in the at least one target terminal device, the in response to the first item contacting with the second item, acquiring the state update information of the first item and/or the state update information of the second item, comprises:
in response to the first item having an ownership corresponding to the first character and the second item having the authority of the virtual space, controlling to make the first item contact with the second item, so that an ownership level of the second item is changed to comprise an authority corresponding to the first character, to acquire the state update information of the second item.

15. The manipulation method according to claim 14, further comprising:
in response to the ownership level of the second item being changed to comprise the authority corresponding to the first character and the state update information of the second item being acquired, treating the state update information corresponding to the second item as the pending state update information to be verified to verify the pending state update information, wherein the current target state information of the target item comprises current target state information of the second item;
wherein in response to acquiring the verification success result, other characters corresponding to the at least one other terminal device except the first terminal device in the at least one target terminal device in the virtual space are informed that the ownership level of the second item is changed to comprise the authority corresponding to the first character and pose information of the second item is synchronized with other characters;
in response to acquiring the verification failure result, the current target state information is used as updated state update information of the second item.

16. The manipulation method according to claim 13, wherein, in response to the determined virtual character comprising a first character corresponding to a first terminal device in the at least one target terminal device and a second character corresponding to a second terminal device in the at least one target terminal device, the in response to the first item contacting with the second item, acquiring the state update information of the first item and/or the state update information of the second item, comprises:
in response to the first item losing an ownership corresponding to the first character and the first item having an authority corresponding to the first character, controlling to make the first item contact with the second item, and acquiring an ownership level of the first item and/or an ownership level of the second item to acquire the state update information of the first item and/or the state update information of the second item.

17. The manipulation method according to claim 16, wherein the controlling to make the first item contact with the second item, and acquiring the ownership level of the first item and/or the ownership level of the second item, comprises:
controlling to make the first item contact with the second object, and in response to the second item having an ownership corresponding to the second character, controlling the ownership level of the first item to be changed to comprise an authority corresponding to the second character;
controlling to make the first item contact with the second object, and in response to the second item having the authority corresponding to the server, controlling the ownership level of the second item to be changed to comprise the authority corresponding to the first character;
controlling to make the first item contact with the second object, and in response to the second item having the authority corresponding to the second character, controlling the ownership level of the second item and the ownership level of the first item to remain unchanged.

18. The manipulation method according to claim 17, further comprising:
in response to controlling the ownership level of the second item to be changed to comprise the authority corresponding to the first character and acquiring the state update information of the second item, treating the state update information corresponding to the second item as the pending state update information to be verified to verify the pending state update information, wherein the current target state information of the target item comprises the current target state information of the second item;
wherein in response to acquiring the verification success result, other characters corresponding to the at least one other terminal device except the first terminal device in the at least one target terminal device in the virtual space are informed that the ownership level of the second item is changed to comprise the authority corresponding to the first character and pose information of the second item is synchronized with other characters;
in response to acquiring the verification failure result, the current target state information of the second item is used as updated state update information of the second item.

19. An electronic device, comprising: a processor and a memory,
wherein the memory stores a computer program, and the computer program, when executed by the processor, implements a manipulation method for a virtual space, wherein the virtual space is created based on a server and at least one target terminal device communicatively connected with the server, at least one first virtual image and at least one second object manipulated by the first virtual image are arranged in the virtual space, the manipulation method comprises:
determining a virtual character corresponding to the target terminal device in the virtual space from the at least one first virtual image; and
in response to a control operation on a target item in the at least one second object in the virtual space, acquiring state update information of the target item based on the control operation, wherein the state update information comprises an ownership level of the target item, and the ownership level of the target item comprises an ownership corresponding to the virtual character and/or an authority corresponding to the virtual space, and the authority of the virtual space comprises an authority corresponding to the virtual character or an authority corresponding to the server.

20. A computer readable storage medium, wherein the storage medium stores a computer program, and the computer program, when executed by a processor, implements a manipulation method for a virtual space,
wherein the virtual space is created based on a server and at least one target terminal device communicatively connected with the server, at least one first virtual image and at least one second object manipulated by the first virtual image are arranged in the virtual space, the manipulation method comprises:
determining a virtual character corresponding to the target terminal device in the virtual space from the at least one first virtual image; and
in response to a control operation on a target item in the at least one second object in the virtual space, acquiring state update information of the target item based on the control operation, wherein the state update information comprises an ownership level of the target item, and the ownership level of the target item comprises an ownership corresponding to the virtual character and/or an authority corresponding to the virtual space, and the authority of the virtual space comprises an authority corresponding to the virtual character or an authority corresponding to the server.
